(19) United States
(12) Patent Application Publication
(10) Pub. No.: US 2008/0273695 A1
(43) Pub. Date: Nov. 6, 2008

(54) Method for elliptic curve scalar multiplication using parameterized projective coordinates

(76) Inventors: Theeb A. Al-Gahtani, Dhahran (SA); Mohammad K. Ibrahim, Dhahran (SA)

Correspondence Address: LITMAN LAW OFFICES, LTD., P.O. BOX 15035, CRYSTAL CITY STATION, ARLINGTON, VA, 22215-0035, US

(21) Appl. No.: 11/797,369

(22) Filed: May 2, 2007

(51) Int. Cl. H04L 9/30

(52) U.S. Cl. 380/30

(57) ABSTRACT

The method for elliptic curve scalar multiplication in an elliptic curve cryptosystem implemented over an insecure communications channel includes the steps of: (a) selecting positive integers Lₓ and L_{y}, wherein Lₓ and L_{y} are not both equal to 1, and wherein L_{y}≠3 if Lₓ=2; (b) representing coordinates of a point P=(x,y) on an elliptic curve of the form F(x,y)=y²−x³−ax−b=0 defined over a finite field as projective coordinates according to transforms

$$x = \frac{X}{{Z}^{{L}_{x}}} and y = \frac{Y}{{Z}^{{L}_{y}}} ,$$

respectively; and (c) adding together K copies, K being a scalar, of the point P(X,Y) to obtain the scalar multiplication product KP. The scalar multiplication product is then converted from parameterized projective coordinates P(X,Y,L^{x},L^{y}) to affine coordinates P(x,y). The method is optimized by restricting L_{y} so that L_{y}−Lₓ≧0 or, alternatively, so that L_{y}=Lₓ. The method may be carried out on a cryptographic device, which may be a computer, a (cellular) telephone, a smart card, an ASIC, or the like.

### BACKGROUND OF THE INVENTION

1. Field of the Invention

The present invention relates to cryptography and methods for encrypting messages for transmission over an insecure communications channel, and particularly to a method for elliptic curve scalar multiplication in a cryptographic system that uses parameterized projective coordinates.

2. Description of the Related Art

Cryptography provides methods of providing privacy and authenticity for remote communications and data storage. Privacy is achieved by encryption of data, usually using the techniques of symmetric cryptography (so called because the same mathematical key is used to encrypt and decrypt the data). Authenticity is achieved by the functions of user identification, data integrity, and message non-repudiation. These are best achieved via asymmetric (or public-key) cryptography.

In particular, public-key cryptography enables encrypted communication between users that have not previously established a shared secret key between them. This is most often done using a combination of symmetric and asymmetric cryptography: public-key techniques are used to establish user identity and a common symmetric key, and a symmetric encryption algorithm is used for the encryption and decryption of the actual messages. The former operation is called key agreement. Prior establishment is necessary in symmetric cryptography, which uses algorithms for which the same key is used to encrypt and decrypt a message.

Public-key cryptography, in contrast, is based on key pairs. A key pair consists of a private key and a public key. As the names imply, the private key is kept private by its owner, while the public key is made public (and typically associated to its owner in, an authenticated manner). In asymmetric encryption, the encryption step is performed using the public key, and decryption using the private key. Thus, the encrypted message can be sent along an insecure channel with the assurance that only the intended recipient can decrypt it.

The key agreement can be interactive (e.g., for encrypting a telephone conversation) or non-interactive (e.g., for electronic mail).

User identification is most easily achieved using what are called identification protocols. A related technique, that of digital signatures, provides data integrity and message non-repudiation in addition to user identification. The public key is used for encryption or signature verification of a given message, and the private key is used for decryption or signature generation of the given message.

The use of cryptographic key pairs was disclosed in U.S. Pat. No. 4,200,770, issued Apr. 29, 1980 to Hellman et al., entitled “CRYPTOGRAPHIC APPARATUS AND METHOD.” The '770 patent also disclosed the application of key pairs to the problem of key agreement over an insecure communication channel. The algorithms specified in the '770 patent rely for their security on the difficulty of the mathematical problem of finding a discrete logarithm. U.S. Pat. No. 4,200,770 is hereby incorporated by reference in its entirety.

In order to undermine the security of a discrete logarithm-based cryptographic algorithm, an adversary must be able to perform the inverse of modular exponentiation (i.e., a discrete logarithm). There are mathematical methods for finding a discrete logarithm (e.g., the Number Field Sieve), but these algorithms cannot be done in any reasonable time using sophisticated computers if certain conditions are met in the specification of the cryptographic algorithm.

In particular, it is necessary that the numbers involved be large enough. The larger the numbers used, the more time and computing power is required to find the discrete logarithm and break the cryptograph. On the other hand, very large numbers lead to very long public keys and transmissions of cryptographic data. The use of very large numbers also requires large amounts of time and computational power in order to perform the cryptographic algorithm. Thus, cryptographers are always looking for ways to minimize the size of the numbers involved, and the time and power required, in performing the encryption and/or authentication algorithms. The payoff for finding such a method is that cryptography can be done faster, cheaper, and in devices that do not have large amounts of computational power (e.g., handheld smart cards).

A discrete-logarithm based cryptographic algorithm can be performed in any mathematical setting in which certain algebraic rules hold true. In mathematical language, the setting must be a finite cyclic group. The choice of the group is critical in a cryptographic system. The discrete logarithm problem may be more difficult in one group than in another for which the numbers are of comparable size. The more difficult the discrete logarithm problem, the smaller the numbers that are required to implement the cryptographic algorithm. Working with smaller numbers is easier and faster than working with larger numbers. Using small numbers allows the cryptographic system to be higher performing (i.e., faster) and requires less storage. So, by choosing the right kind of group, a user may be able to work with smaller numbers, make a faster cryptographic system, and get the same, or better, cryptographic strength than from another cryptographic system that uses larger numbers.

The groups referred to above come from a setting called finite fields. Methods of adapting discrete logarithm-based algorithms to the setting of elliptic curves are known. However, finding discrete logarithms in this kind of group is particularly difficult. Thus, elliptic curve-based cryptographic algorithms can be implemented using much smaller numbers than in a finite field setting of comparable cryptographic strength. Thus, the use of elliptic curve cryptography is an improvement over finite field-based public-key cryptography.

In practice, an Elliptic Curve group over Fields F(p), denoted as E(p), is formed by choosing a pair of a and b coefficients, which are elements within F(p). The group consists of a finite set of points P(x,y) that satisfy the elliptic curve equation:

F(x,y)=y²−x³−ax−b=0 1.1

together with a point at infinity, O. The coordinates of the point, x and y, are elements of F(p) represented in N-bit strings. In what follows, a point is either written as a capital letter, e.g., P, or as a pair in terms of the affine coordinates, i.e., (x,y).

The Elliptic Curve Cryptosystem relies upon the difficulty of the Elliptic Curve Discrete Logarithm Problem (ECDLP) to provide its effectiveness as a cryptosystem. Using multiplicative notation, the problem can be described as: given points B and Q in the group, find a number k such that B^{k}=Q, where k is called the discrete logarithm of Q to the base B. Using additive notation, the problem becomes: given two points B and Q in the group, find a number k such that kB=Q.

In an Elliptic Curve Cryptosystem, the large integer k is kept private and is often referred to as the secret key. The point Q together with the base point B are made public and are referred to as the public key. The security of the system, thus, relies upon the difficulty of deriving the secret k, knowing the public points B and Q. The main factor that determines the security strength of such a system is the size of its underlying finite field. In a real cryptographic application, the underlying field is made so large that it is computationally infeasible to determine k in a straightforward way by computing all the multiples of B until Q is found.

The core of elliptic curve geometric arithmetic is an operation called scalar multiplication, which computes kB by adding together k copies of the point B. Scalar multiplication is performed through a combination of point doubling and point addition operations. The point addition operation adds two distinct points together and the point doubling operation adds two copies of a point together. To compute, for example, 11B=(2*(2*(2B)))+3B=Q, it would take three point doublings and one point-addition.

Addition of two points on an elliptic curve is calculated as follows. When a straight line is drawn through the two points, the straight line intersects the elliptic curve at a third point. The point symmetric to this third intersecting point with respect to the x-axis is defined as a point resulting from the addition.

Doubling a point on an elliptic curve is calculated as follows. When a tangent line is drawn at a point on an elliptic curve, the tangent line intersects the elliptic curve at another point. The point symmetric to this intersecting point with respect to the x-axis is defined as a point resulting from the doubling.

Table 1 illustrates the addition rules for adding two points (x₁,y₁) and (x₂,y₂), that is,

(x₃,y₃)=(x₁,y₁)+(x₂,y₂) 1.2

TABLE I
Summary of Addition Rules

| | |
|---|---|
| General Equations | x₃ = m³ − x₂ − x₁ |
| | y₃ = m(x₃ − x₁) + y₁ |
| Point Addition | $m = \frac{{y}_{2} - {y}_{1}}{{x}_{2} - {x}_{1}}$ |
| Point Doubling (x₃, y₃) = 2(x₁, y₁) | $m = \frac{3 {x}_{1}^{2} - a}{2 {y}_{1}}$ |
| (x₂, y₂) = −(x, y₁) | (x₃, y₃) = (x₁, y₁) + (−(x₁, y₁)) = 0 |
| (x₂, y₂) = 0 | (x₃, y₃) = (x₁, y₁) + 0 = (x₁, y₁) |
| −(x₁, y₁) | = (x₁, −y₁) |

Given a message point (xₘ,yₘ), a base point (x_{B,yB}), and a given key, k, the cipher point (x_{C},y_{C}) is obtained using the following equation,

(x_{C},y_{C})=(xₘ,yₘ)+k(x_{B},y_{B}) 1.3

There are two basics steps in the computation of the above equations. The first is to find the scalar multiplication of the base point with the key, “k(x_{B},y_{B})”. The resulting point is then added to the message point, (xₘ, yₘ).to obtain the cipher point. At the receiver, the message point is recovered from: the cipher point, which is usually transmitted; the shared key; and the base point, that is

(xₘ,yₘ)=(x_{C},y_{C})−k(x_{B},y_{B}) 1.4

The steps of elliptic curve symmetric cryptography can be summarized as follows. Both the sender and receiver must agree on: (1) A random number, k, that will be the shared secret key for communication; and (2) A base point, P=(X_{B}, Y_{B}).

At the sending correspondent, (1) Embed a message bit string into the x coordinate of an elliptic curve point, which is designated as the message point, (xₘ, yₘ); (2) The cipher point (xC, YC) is computed using, (x_{c},y_{C})=(xₘ,yₘ)+k(x_{B}, y_{B}); and (3) The appropriate bits of the x-coordinate and the sign bit of the y-coordinate of the cipher point (x_{c},y_{c}) are sent to the receiving entity.

At the receiving correspondent, the following steps are performed. (1) Using the shared key, k, and the base point (x_{B}, y_{B}), the scalar multiplication (x_{Bk}, y_{Bk})=k(x_{B}, y_{B}) is computed; (2) The message point (xₘ,yₘ) is computed using (xₘ,yₘ)=(x_{c},y_{c})+(−k(x_{B},y_{B})); and (3) The secret message's bit string is recovered from xₘ.

The steps of elliptic curve public-key cryptography can be summarized as follows. Both the sender and receiver must agree on (1) An elliptic curve; and (2) A base point, P (x_{B}, y_{B}). At the sending correspondent, (1) Embed a message bit string into the x-coordinate of an elliptic curve point, which is designated as the message point, (xₘ, yₘ); (2) Using the private key of the sending correspondent, k_{SPr}, and the public key of the receiving correspondent, k_{RPr}(x_{b}. y_{b}), compute the scalar multiplication (x_{bk}, y_{bk})=k_{SPr}(k_{RPr}(x_{b},y_{b})); (3) Compute a cipher point (x_{c},y_{c}) using (x_{c},y_{c}=(xₘ,yₘ)+(x_{bk}, y_{bk}), and (4) Send appropriate bits of the x-coordinate and the sign bit of the y-coordinate of the cipher point (x_{c},y_{c}).to the receiving correspondent.

At the receiving correspondent, (1) Using the private key of the receiving correspondent, k_{RPr}, and the public key of the sending correspondent, k_{Spr}(x_{b}, y_{b}), compute the scalar multiplication (x_{bk}, y_{bk})=k_{RPr}(k_{SPr}(x_{b}, y_{b})); (2) Compute the message point (xₘ,yₘ) using (xₘ,yₘ)=(x_{c},y_{c})−(x_{bk}, y_{bk}); and (3) Recover the message bit string from Xₘ.

Scalar multiplication (SM) (or point multiplication) refers to computing the point:

KP=P+P+P+ . . . P (sum taken K times)

on the elliptic curve over a given .finite field. The integer K is referred to as “scalar” and the point P as the base point. Adding the point P to itself K times is not an efficient way to compute scalar multiplication. More efficient methods are based on a sequence of addition (ADD) and doubling (DBL) operations. The doubling operation is simply adding the point to itself.

The computation of the point KP processed by the scalar multiplication is performed using the binary expression of K represented by the equation:

K=kₙ₋₁2ⁿ⁻¹+kₙ₋₂2ⁿ⁻²+ . . . +k₁2+k₀

where kᵢ is the i-th bit of the binary representation of K, and n is the total number of bits.

There are two main methods of calculating KP. The Least-to-Most (LM) algorithm, which starts from the least significant bit of K, and the Most-to-Least (ML) algorithm which starts from the most significant bit of K. The LM and the ML algorithms are shown below.

Algorithm 1: Least-to-Most Binary Method Algorithm

| | |
|---|---|
| INPUT | K, P |
| OUTPUT | KP |

```
    1.  Initialize Q[0] = O, Q[1] = P
    2.  for i=0 to n−1
    3.  if k[i]==1 then
    4.  Q[0]=ADD(Q[0],Q[1])
    5.  end if
    6.  Q[1]=DBL(Q[1])
    7.  end for
    8.  return Q[0]
```

In the LM algorithm, Q[0] is initialized to the identity point O, and Q[1] is initialized to the base point P. If kᵢ=1, the elliptic curve addition, ADD, is performed on the points Q[0] and Q[1] in step 4, and the result is stored in the point Q[0]; otherwise, (i.e., for kᵢ=0) Q[0] remains unchanged. The elliptic curve doubling, DBL, is performed on the point Q[1] in step 6, and the result is stored in the point Q[1]. This point doubling operation in step 6 is performed in all cases, regardless of the scalar bit value.

Algorithm 2: Most-to-Least Binary Method Algorithm

| | |
|---|---|
| INPUT | K, P |
| OUTPUT | KP |

```
    1.  Initialize Q[0] = P
    2.  for i= n−2 downto 0
    3.  Q[0]=DBL(Q[0])
    4.  if k[i]==1 then
    5.  Q[0]=ADD(Q[0],P)
    6.  end if
    7.  end for
    8.  return Q[0]
```

The ML algorithm treats the bit string of K starting with the most significant bit first. Since the most significant bit is always 1, the ML algorithm starts from the nextmost bit, n−2, and initializes Q[0] to P. This kind of algorithm needs only one variable, Q[0]. First, the DBL operation is performed on Q[0], and the result is stored in Q[0], as shown in step 3. This point doubling in step 3 is performed regardless of the scalar bit value. If kᵢ=1, the ADD operation is performed on the point Q[0] and the base point P in step 5, and the result is stored in point Q[0]; otherwise, (i.e. for kᵢ=0) Q[0] remains unchanged.

The difficulty in solving the elliptic curve discrete logarithm problem has been established theoretically. However, information associated with secret information, such as the private key or the like, may leak out in cryptographic processing in real mounting. Thus, there has been proposed an attack method of so-called power analysis, in which the secret information is decrypted on the basis of the leaked information.

An attack method in which change in voltage is measured in cryptographic processing using secret information, such as DES (Data Encryption Standard) or the like, so that the process of the cryptographic processing is obtained and the secret information inferred on the basis of the obtained process, is called DPA (Differential Power Analysis).

As shown in Algorithm 1 and Algorithm 2, performing the ADD operation is conditioned by the key bit. If the scalar bit value is equal to one, an ADD operation is performed; otherwise, an ADD operation is not performed. Therefore, a simple power analysis (i.e., simple side channel analysis using power consumption as the side channel) will produce different power traces that distinguish between the existence of an ADD operation or not. This can reveal the bit values of the scalar.

One widely used approach to avoid this kind of leak to perform a dummy addition in the ML method when the processed bit is ‘0’ so that each iteration appears as a doubling followed by an addition operation, which is called the “Double-and-ADD always algorithm”, shown below for the ML technique as Algorithm 3, with a similar algorithm for the LM technique shown below as Algorithm 4.

Algorithm 3: ML Double-and-ADD always algorithm

| | |
|---|---|
| INPUT | K,P |
| OUTPUT | KP |

```
    1.  Initialize Q[2]=P
    2.  for i=n−2 downto 0
    3.  Q[0]=DBL(Q[2])
    4.  Q[1]=ADD(Q[0],P)
    5.  Q[2]=Q[kᵢ]
    6.  end for
        return Q[2]
```

Algorithm 4: LM Double-and-ADD always algorithm

| | |
|---|---|
| INPUT | K,P |
| OUTPUT | KP |

```
    1.  Initialize Q[2]=P
    2.  for i=n−2 downto 0
    3.  Q[0]=DBL(Q[2])
    4.  Q[1]=ADD(Q[0],P)
    5.  Q[2]=Q[kᵢ]
    6.  end for
        return Q[2]
```

Another ML algorithm to avoid this kind of leak is disclosed in U.S. Patent Application No. 2003/01 23656, published Jul. 3, 2003, entitled “ELLIPTIC CURVE CRYPTOSYSTEM APPARATUS, STORAGE MEDIUM STORING ELLIPTIC CURVE CRYPTOSYSTEM PROGRAM, AND ELLIPTIC CURVE CRYPTOSYSTEM ARITHMETIC METHOD”. This algorithm uses extra ADD operations to assure that the sequence of DBL and ADD operations is carried out in each iteration. We refer to this algorithm as Takagi's algorithm, shown below as Algorithm 5.

Algorithm 5: Takagi's ML algorithm

| | |
|---|---|
| INPUT | K,P |
| OUTPUT | KP |

```
    1.  INITIALIZE Q[0]=P; Q[1]=2P
    2.  for i=n−2 down to 0
    3.  Q[2]=DBL(Q[kᵢ])
    4.  Q[1]=ADD(Q[0],Q[1])
    5.  Q[0]=Q[2−kᵢ]
    6.  Q[1]=Q[1+kᵢ]
    7.  end for
      return Q[0]
```

Even if an algorithm is protected against single power analysis, it may succumb to the more sophisticated differential power analysis (DPA). Assume that the double-and-add always method is implemented with one of the previous algorithms given in Algorithms 3, 4 or 5. Representing the scalar value K in binary:

K=kₙ₋₁2ⁿ⁻¹+kₙ_{_{—}}₂2ⁿ^{_{—}}²+ . . . +kᵢ2+k₀

where kᵢ is the i-th bit of the binary representation of K, and n is the total number of bits. DPA is based on the assumption that an attacker already knows the highest bits, kₙ₋₁, kₙ₋₂, . . . kⱼ₊₁ of K. Then, he guesses that the next bit kⱼ is equal to ‘1’, and then randomly chooses several points P₁, . . . , Pₜ and computes:

$${Q}_{r} = ( {\sum }_{i = j}^{n - 1} {k}_{i} {2}^{i - j} ) {P}_{r} For 1 \leq r \leq t$$

Based on statistical analysis of these points (i.e., Qᵣ, 1≦r≦t), he can decide whether his guess is correct or not. Once kⱼ is known, the remaining bits, kⱼ_{_{—}}₁, kⱼ_{_{—}}₂ . . . , k₀, are recovered recursively in the same way.

J. Coron proposed the following randomization-based countermeasures, which are effective against differential power analysis attacks: (1) Randomizing the base-point P by computing Q=kP as Q=(P+R)−kR for a random point R; (2) Using randomized projective coordinates, i.e., for a random number r≠0, the projective coordinates, (X, Y, Z) and (rX, rY, rZ) represent the same point, so that for a random number r, if P=(x₀,y₀), Q is computed as Q=k(rx₀, ry₀,: r); (3) Randomizing the scalar K, i.e., if n=ord_{E}(P) denotes the order of PεE(F(p)), then Q is computed as Q=(k+rn)P for a random r, or, alternatively, one can replace n by the order of the elliptic curve, #E(F(p)).

These countermeasures can be used with Coron's algorithm or Takagi's algorithm to protect scalar multiplication computation against both simple power attacks and differential power analysis attacks.

One of the crucial decisions when implementing an efficient elliptic curve cryptosystem over GF(p) is deciding which point coordinate system to use. The point coordinate system used for addition and doubling of points on the elliptic curve determines the efficiency of these routines, and hence the efficiency of the basic cryptographic operation, scalar multiplication

There are many techniques proposed for fast implementations of elliptic curve cryptosystems. One of the most important techniques that can be used to enhance scalar multiplication is the idea of transferring the point coordinates into other coordinates that can eliminate the inverse operation.

Various coordinates can be used in order to eliminate the inverse operation in scalar multiplication and, hence, increase the speed of calculations. We still need one final inverse operation to return back to the normal (Affine) coordinates after completing scalar multiplication. There are potentially five different coordinate systems, which can be summarized as: Affine (A), Projective (P), Jacobian (J), Chudnovsky-Jacobian (C), and Modified (M) coordinates. The computation times in terms of number of multiplication (M), squaring (S), and inverse (I) operations are computed for each coordinate system. For simplicity, the addition and subtraction operations are not considered, since they require very little time.

### Affine Coordinates (A)

Affine coordinates are the simplest to understand and are used for communication between two parties because they require the lowest bandwidth. However, the modular inversions required when adding and doubling points that are represented using Affine coordinates cause them to be highly inefficient for use in addition and doubling of points. The other coordinate systems require at least one extra value to represent a point and do not require the use of modular inversions in point addition and doubling, but extra multiplication and squaring operations are required instead.

For Affine coordinates, let

ECE:y²=x³+ax+b(a,b εFp,4a³+27b²≠0) 3.1

be the equation of elliptic curve E over Fₚ. This equation will be referred to as ECE.

Let P=(x₁,y₁), Q=(x₂,y₂) be points on E. It is desired to find R=P+Q=(x₃,y₃). The affine formulas for addition are given by:

x₃=λ²x₁−x₂

y₃=λ(x₁−x₃)−y₁ 3.2

Where: λ=(y₂−y₁)/(x₂−x₁) 3.2

and where P≠Q. The affine formulas for point doubling (R=2P) are given by:

x₃=λ²−2ₓ_{₁}

y₃=λ(x₁−x₃)−y₁

Where: λ=(3x₁²+a)/(2 y₁) 3.3

### Projective Coordinates (P)

In projective coordinates, the following transformation is used:

$$x = \frac{X}{Z} and y = \frac{Y}{Z}$$

The ECE becomes:

Y²Z=X³+aXZ²+bZ³ 3.4

In this case, the points P,Q, and Rare represented as follows:

P=(X₁,Y₁,Z₁),Q=(X₂, Y₂,Z₂) and R=P+Q=(X₃,Y₃,Z₃)

The addition formulas where P≠Q are given by:

X₃ vA, Y₃=u(v²X₁Z₂−A)−v³Y₁Z₂, Z₃ v³Z₁Z₂ 3.5

where:

u=Y₂Z₁−Y₁Z₂, v=X₂Z₁−X₁Z₂ and A=u²Z₁Z₂−v³−2v²X₁Z₂

The doubling formula is given by:

X₃=2hs, Y₃=w(4b−h)−8Y₁²s²,Z₃=8s³ 3.6

where

w=aZ₁²+3X₁², s=Y₁Z₁, B=X₁Y₁s and h=w²−8B

### Jacobian Coordinates (J)

In Jacobian coordinates, the following transformation is used:

$$x = \frac{X}{{Z}^{2}} and y = \frac{Y}{{Z}^{3}}$$

The ECE becomes:

Y²=X³+aXZ⁴+bZ⁶

In this case, the points P, Q, and R have three coordinates X, Y, and Z as follows:

P=(X₁,Y₁,Z₁), Q=(X₂,Y₂,Z₂), and R=P+Q=(X₃,Y₃,Z₃)

The addition formula, where P≠Q, is given by:

X₃=−H³−2U₁H²+r², Y₃=−S₁H³+r(U₁H²−X₃), Z₃=Z₁Z₂H 3.7

where:

U₁=X₁Z₂², U₂=X₂Z₁², S₁=Y₁Z₂³, S₂=Y₂Z₁³, H=U₂−U₁, and r=S₂−S₁

The doubling formula is given by:

X₃=T, Y₃=−8Y₁⁴+M(S−T), Z₃=2Y₁Z₁ 3.8

where

S=4X₁Y₁², M=3X₁²+aZ₁⁴, and T=−2S+M²

### Chudnovsky-Jacobian Coordinates (C)

It is clear that Jacobian coordinates provide faster doubling and slower addition compared to projective coordinates. In order to speedup addition, D. V. Chudnovsky proposed the Chudnovsky-Jacobian coordinates. In this coordinate system, a Jacobian point is represented internally as 5-tupel point (X, Y, Z, Z₂, Z₃). The transformation and ECE equations are the same as in Jacobian coordinates, while the points PQ, and R represented as follows:

P=(X₁,Y₁,Z₁,Z₁²,Z₁³),Q=(X₂,Y₂,Z₂,Z₂²,Z₂³), and R=P+Q=(X₃,Y₃,Z₃ ,Z₃²,Z₃³)

The main idea in Chudnovsky-Jacobian coordinate is that the Z₂, Z₃ are ready for use from the previous iteration and there is no need to re-calculate them. In other words, Z₁², Z₁³, Z₂², Z₂³ are computed during the last iteration and fed to the current iteration as inputs, while Z₃²,Z₃³ need to be calculated.

The addition formula for Chudnovsky-Jacobian coordinates, where P≠Q, is given by:

X₃=−H³−2U₁H²+r², Y₃=−S₁H³+r(U₁H²−X₃), Z₃=Z₁Z₂Z₃²=Z₃²,Z₃³=Z₃³ 3.9

where:

U₁=X¹Z₂², U₂=X₂Z₁², S₁=Y₁Z₂³, S₂=Y₂Z₁³, H=U₂−U₁, and r=S₂−S₁

The doubling formula (R=2P) for Chudnovsky-Jacobian coordinates is given by:

X₃=T, Y₃=−8Y₁⁴+M(S−T), Z₃=2Y₁Z₁Z₃²=Z₃², Z₃³=Z₃³ 3.10

where:

S=4X₁Y₁², M=3X₁²+a(Z₁²)², and T=−2S+M²

### Modified Jacobian Coordinates (M)

Henri Cohen et. al. modified the Jacobian coordinates and claimed that the modification resulted in the fastest possible point doubling. The term (aZ⁴) is needed in doubling, rather than in addition. Taking this into consideration, the modified Jacobian coordinates employed the same idea of internally representing this term and providing it as input to the doubling formula. The point is represented in 4-tuple representation (X, Y, Z, aZ⁴). It uses the same transformation equations used in Jacobian coordinates.

In modified Jacobian coordinates, the points P, Q and R are represented as follows:

P=(X₁,Y₁,Z₁,aZ₁⁴), Q=(X₂,Y₂,Z₂,aZ₂⁴) and R=P+Q=(X₃,Y₃, Z₃, aZ₃⁴)

In modified Jacobian coordinates, the addition formula, where P#Q, is given by:

X₃=−H³2U₁H²+r², Y₃=−S₁H³+r(U₁H²−X₃), Z₃=Z₁Z₂H aZ₃⁴=aZ₃⁴ 3.11

where:

U₁=X₁Z₂²,U₂=X₂Z₁², S₁=Y₁Z₂³, S₂=Y₂Z₁³, H=U₂=U₁, and r=S₂−S₁

The doubling formula in modified Jacobian coordinates/is given by:

X₃=T, Y₃=M(S−T)−U, Z₃=2Y₁Z₁aZ₃⁴=2U(aZ₁⁴) 3.12

where:

S=4X₁Y₁², U=8Y₁⁴, M=3X₁²2+aZ₁⁴, and T=−2S+M²

None of the above inventions, methodologies and patents, taken either singly or in combination, is seen to describe the instant invention as claimed. Thus, a method for elliptic curve scalar multiplication using parameterized projective coordinates solving the aforementioned problems is desired.

### SUMMARY OF THE INVENTION

The method for elliptic curve scalar multiplication in an elliptic curve cryptosystem implemented over an insecure communications channel includes the steps of: (a) selecting positive integers Lₓ and L_{y}, wherein Lₓ and L_{y} are not both equal to, 1, and wherein L_{y}≠3 if Lₓ=2; (b) representing coordinates of a point P=(x,y) on an elliptic curve of the form F(x,y)=y²−x³−ax−b=0 defined over a finite field as projective coordinates according to transforms

$$x = \frac{X}{{Z}^{{L}_{x}}} and y = \frac{Y}{{Z}^{{L}_{y}}} ,$$

respectively; and (c) adding together K copies, K being a scalar, of the point P(X,Y) to obtain the scalar multiplication product KP. The scalar multiplication product is then converted from parameterized projective coordinates P(X,Y,L^{x},L^{y}) to affine coordinates P(x,y). The method is optimized by restricting L_{y} so that L_{y}−Lₓ≧0 or, alternatively, so that L_{y}=Lₓ. The method may be carried out on a cryptographic device, which may be a computer, a (cellular) telephone, a smart card, an ASIC, or the like.

The method for elliptic curve scalar multiplication using parameterized projective coordinates allows a computing and/or encrypting device to select the projective coordinate system either at random, or according to a certain rule. The parameterized projective coordinate (PPC) method automates the selection of the projective coordinate system and uses a single mathematical formulation (which may be implemented in software code) to implement different projective coordinate systems.

Different projective coordinates can be implemented by using two parameters, where one parameter defines the projection of the x-coordinate and a second parameter defines the projection of the y-coordinate of an elliptic curve point. This process allows different projective coordinates to be used within the same mathematical formulation in calculating the same scalar multiplication. Thus, the computation of the same scalar multiplication can be randomized by simply varying either the x-coordinate projecting parameter and/or the y-coordinate projecting parameter. The PPC method does not require the sending and receiving correspondents to use the same projective coordinates in computing the same scalar multiplication.

In PPC, two values, namely Z^{L}^{ₓ} and Z^{L}^{_{y}}, are used for projecting the x-coordinate and the y-coordinate, respectively, of a point. Lₓ and L_{y} are powers that can be chosen either at random or according to a certain criteria, such as a criteria for reducing the computation complexity.

To formulate the Parameterized Projective Coordinates, consider that there are N+1 degrees of powers for the Z-coordinate; i.e., from 0 to N as follows:

Degree-0 is the affine coordinate system P=(x,y);

In Degree-1,

$$x = \frac{X}{Z} , y = \frac{Y}{Z} ;$$

In Degree-2,

$$x = \frac{X}{{Z}^{2}} , y = \frac{Y}{{Z}^{2}} ;$$

In Degree-i,

$$x = \frac{X}{{Z}^{i}} , y = \frac{Y}{{Z}^{i}} ;$$

and

In Degree-N,

$$x = \frac{X}{{Z}^{N}} , y = \frac{Y}{{Z}^{N}} .$$

In the PPC method, the x- and y-coordinates can be projected to any degree of the above degrees and not necessarily to the same degree. In other words, the x-coordinate can be in one degree while the y-coordinate may be in another degree, resulting in many combinations of coordinate systems.

Lₓ and L_{y} are degrees of the Z-coordinate, which can be chosen in the range from 1 to N. Based on this, we define the following Parameterized Transformation Functions (PTF):

$$x = \frac{X}{{Z}^{{L}_{x}}} and y = \frac{Y}{{Z}^{{L}_{y}}} , \qquad 4.2$$

where, 0<Lₓ≦N and 0<L_{y}≦N.

By substituting for x and y from equation (24) in the elliptic curve equation, E:y²=x³+ax+b, we get:

$$\frac{{Y}^{2}}{{Z}^{2 {L}_{y}}} = \frac{{X}^{3}}{{Z}^{3 {L}_{x}}} + a \frac{X}{{Z}^{{L}_{x}}} + b \qquad 4.3$$

which can be written as

$$\frac{{Y}^{2}}{{Z}^{2 {L}_{y}}} = \frac{{X}^{3} + {aXZ}^{2 {L}_{x}} + {bZ}^{3 {L}_{x}}}{{Z}^{3 {L}_{x}}}$$

and simplified to

Y²Z^{3L}^{ₓ}^{-2L}^{ₓ}=X³+aXZ^{2L}^{ₓ}+bZ^{3L}^{ₓ} 4.4

We note that if we set Lₓ=L=1, then equation 4.4 becomes:

Y²Z=X³+aXZ²+bZ³ 4.5

which is identical to homogenous projective coordinate equation 3.4 discussed above.

Equations for elliptic curve point addition and doubling may be derived and used for any values for Lₓ and L_{y}, and, thus, the same mathematical formulation can be used to implement point addition and doubling using any projective coordinate. The appropriate projective coordinate is selected based on the values of projecting parameters Lₓ and L_{y}.

These and other features of the present invention will become readily apparent upon further review of the following specification and drawings.

### DETAILED DESCRIPTION OF THE PREFERRED EMBODIMENTS

The method for elliptic curve scalar multiplication in an elliptic curve cryptosystem implemented over an insecure communications channel includes the steps of: (a) selecting positive integers Lₓ and L_{y}, wherein Lₓ and L_{y} are not both equal to 1, and wherein L_{y} ≠3 if Lₓ=2; (b) representing coordinates of a point P=(x,y) on an elliptic curve of the form F(x,y)=y²−x³−ax−b=0 defined over a finite field as projective coordinates according to transforms

$$x = \frac{X}{{Z}^{{L}_{x}}} and y = \frac{Y}{{Z}^{{L}_{y}}} ,$$

respectively; and (c) adding together K copies, K being a scalar, of the point P(X,Y) to obtain the scalar multiplication product KP. The scalar multiplication product is then converted from parameterized projective coordinates P(X,Y,L^{x},L^{y}) to affine coordinates P(x,y). The method is optimized by restricting L_{y} so that L_{y}−Lₓ≧0 or, alternatively, so that L_{y}=Lₓ. The method may be carried out on a cryptographic device, which may be a computer, a (cellular) telephone, a smart card, an ASIC, or the like.

The method for elliptic curve scalar multiplication using parameterized projective coordinates allows a computing and/or encrypting device to select the projective coordinate system either at random, or according to a certain rule. The parameterized projective coordinate (PPC) method automates the selection of the projective coordinate system and uses a single mathematical formulation (which may be implemented in software code) to implement different projective coordinate systems.

Different projective coordinates can be implemented by using two parameters, where one parameter defines the projection of the x-coordinate and a second parameter defines the projection of the y-coordinate of an elliptic curve point. This process allows different projective coordinates to be used within the same mathematical formulation in calculating the same scalar multiplication. Thus, the/computation of the same scalar multiplication can be randomized by simply varying either the x-coordinate projecting parameter and/or the y-coordinate projecting parameter. The PPC method does not require the sending and receiving correspondents to use the same projective coordinates in computing the same scalar multiplication.

In PPC, two values, namely Z^{L}^{ₓ} and Z^{L}^{_{y}}, are used for projecting the x-coordinate and the y-coordinate, respectively, of a point. Lₓ and L_{y} are powers that can be chosen either at random or according to a certain criteria, such as a criteria for reducing the computation complexity.

To formulate the Parameterized Projective Coordinates, consider that there are N+1 degrees of powers for the Z-coordinate; i.e., from 0 to N as follows:

Degree-0 is the affine coordinate system P=(x,y);

In Degree-1,

$$x = \frac{X}{Z} , y = \frac{Y}{Z} ;$$

In Degree-2,

$$x = \frac{X}{{Z}^{2}} , y = \frac{Y}{{Z}^{2}} ;$$

In Degree-i,

$$x = \frac{X}{{Z}^{i}} , y = \frac{Y}{{Z}^{i}} ;$$

and

In Degree-N,

$$x = \frac{X}{{Z}^{N}} , y = \frac{Y}{{Z}^{N}} .$$

In the PPC method, the x- and y-coordinates can be projected to any degree of the above degrees and not necessarily to the same degree. In other words, the x-coordinate can be in one degree while the y-coordinate may be in another degree, resulting in many combinations of coordinate systems.

Lₓ and L_{y} are degrees of the Z-coordinate, which can be chosen in the range from 1 to N. Based on this, we define the following Parameterized Transformation Functions (PTF):

$$x = \frac{X}{{Z}^{{L}_{x}}} and y = \frac{Y}{{Z}^{{L}_{y}}} , \qquad 4.2$$

where, 0<Lₓ≦N and 0<L_{y}≦N.

By substituting for x and y from equation (24) in the elliptic curve equation, E: y²=x³+ax+b, we get:

$$\frac{{Y}^{2}}{{Z}^{2 {L}_{y}}} = \frac{{X}^{3}}{{Z}^{3 {L}_{x}}} + a \frac{X}{{Z}^{{L}_{x}}} + b \qquad 4.3$$

which can be written as

$$\frac{{Y}^{2}}{{Z}^{2 {L}_{y}}} = \frac{{X}^{3} + {aXZ}^{2 {L}_{x}} + {bZ}^{3 {L}_{x}}}{{Z}^{3 {L}_{x}}}$$

and simplified to

Y²Z^{3L}^{ₓ}^{-2L}^{ₓ}=X³+aXZ^{2L}^{ₓ}+bZ^{3L}^{ₓ} 4.4

We note that if we set Lₓ=L_{y}=1, then equation 4.4 becomes:

Y²Z=X³+aXZ²+bZ³ 4.5

which is identical to homogenous projective coordinate equation 3.4 discussed above.

Equations for elliptic curve point addition and doubling may be derived and used for any values for Lₓ and L_{y}, and, thus, the same mathematical formulation can be used to implement point addition and doubling using any projective coordinate. The appropriate projective coordinate is selected based on the values of projecting parameters Lₓ and L_{y}.

### Addition

Further elaborating on the addition formulas in the PPC method, we let P=(x₁,y₁) and Q=(x₂,y₂) be two points satisfying the elliptic curve equation. Then, the affine coordinates of the point R=(x₃,y₃)=P+Q are given by

$$\begin{matrix}{x}_{3} = {λ}^{2} - {x}_{1} - {x}_{2} & 4.6 a \\ {y}_{3} = λ ( {x}_{1} - {x}_{3} ) - {y}_{1} \\ where λ = \frac{{y}_{2} - {y}_{1}}{{x}_{2} - {x}_{1}} . & 4.6 b\end{matrix}$$

The parameterized transformation functions shown in equations 4.2 are used to get the parameterized projective coordinates (X₃,Y₃,Z₃^{L}^{ₓ},Z₃^{L}^{_{y}}) of the point R according to equations 4.6a and 4.6b. The derivations of X₃ and Y₃ are given below.

In order to derive X₃ from x₃, we consider applying the parameterized transformation functions shown in equation 4.2 to the x-coordinate equation 4.6a, letting P=(X₁,Y₁,Z₁^{L}^{ₓ},Z₁^{L}^{_{y}}), Q=(X₂,Y₂, Z₂^{L}^{ₓ},Z₂^{L}^{_{y}}) and R=(X₃,Y₃,Z₃^{L}^{ₓ},Z₃^{L}^{_{y}}). Then, the projected X₃ coordinate of the point R=P+Q can be derived as follows.

By applying the parameterized transformation functions of equation 4.2 to equation 4.6a, we get:

$$\frac{{X}_{3}}{{Z}_{3}^{{L}_{x}}} = {( \frac{\frac{{Y}_{2}}{{Z}_{2}^{{L}_{y}}} - \frac{{Y}_{1}}{{Z}_{1}^{{L}_{y}}}}{\frac{{X}_{2}}{{Z}_{2}^{{L}_{x}}} - \frac{{X}_{1}}{{Z}_{1}^{{L}_{x}}}} )}^{2} - \frac{{X}_{1}}{{Z}_{1}^{{L}_{x}}} - \frac{{X}_{2}}{{Z}_{2}^{{L}_{x}}} .$$

We then unify the denominators to get:

$$= {( \frac{\frac{{Y}_{2} {Z}_{1}^{{L}_{y}} - {Y}_{1} {Z}_{2}^{{L}_{y}}}{{Z}_{1}^{{L}_{y}} {Z}_{2}^{{L}_{y}}}}{\frac{{X}_{2} {Z}_{1}^{{L}_{x}} - {X}_{1} {Z}_{2}^{{L}_{x}}}{{Z}_{1}^{{L}_{x}} {Z}_{2}^{{L}_{x}}}} )}^{2} - \frac{{X}_{1} {Z}_{2}^{{L}_{x}} + {X}_{2} {Z}_{1}^{{L}_{x}}}{{Z}_{1}^{{L}_{x}} {Z}_{2}^{{L}_{x}}} \\ = {( \frac{( {Y}_{2} {Z}_{1}^{{L}_{y}} - {Y}_{1} {Z}_{2}^{{L}_{y}} ) ( {Z}_{1}^{{L}_{x}} {Z}_{2}^{{L}_{x}} )}{( {X}_{2} {Z}_{1}^{{L}_{x}} - {X}_{1} {Z}_{2}^{{L}_{x}} ) ( {Z}_{1}^{{L}_{y}} {Z}_{2}^{{L}_{y}} )} )}^{2} - \frac{{X}_{1} {Z}_{2}^{{L}_{x}} + {X}_{2} {Z}_{1}^{{L}_{x}}}{{Z}_{1}^{{L}_{x}} {Z}_{2}^{{L}_{x}}}$$

Next, we let U=Y₂Z₁^{L}^{_{y}}−Y₁Z₂^{L}^{_{y}}, V=X₂Z₁^{L}^{ₓ}−X₁Z₂^{L}^{ₓ} and S=X₂Z₁^{L}^{ₓ}+X₁Z₂^{L}^{ₓ}, so that we now have

$$\frac{{X}_{3}}{{Z}_{3}^{{L}_{x}}} = \frac{{{U}^{2} ( {Z}_{1}^{{L}_{x}} {Z}_{2}^{{L}_{x}} )}^{2}}{{{V}^{2} ( {Z}_{1}^{{L}_{y}} {Z}_{2}^{{L}_{y}} )}^{2}} - \frac{S}{{Z}_{1}^{{L}_{x}} {Z}_{2}^{{L}_{x}}} \\ = \frac{{{U}^{2} ( {Z}_{1}^{{L}_{x}} {Z}_{2}^{{L}_{x}} )}^{3} - {{SV}^{2} ( {Z}_{1}^{{L}_{y}} {Z}_{2}^{{L}_{y}} )}^{2}}{{{V}^{2} ( {Z}_{1}^{{L}_{y}} {Z}_{2}^{{L}_{y}} )}^{2} {Z}_{1}^{{L}_{x}} {Z}_{2}^{{L}_{x}}} . \\ We then let {X}_{3}^{′} = {{U}^{2} ( {Z}_{1}^{{L}_{x}} {Z}_{2}^{{L}_{x}} )}^{3} - {{SV}^{2} ( {Z}_{1}^{{L}_{y}} {Z}_{2}^{{L}_{y}} )}^{2} \qquad 4.7$$

so that

$$\frac{{X}_{3}}{{Z}_{3}^{{L}_{x}}} = \frac{{X}_{3}^{′}}{{{V}^{2} ( {Z}_{1}^{{L}_{y}} {Z}_{2}^{{L}_{y}} )}^{2} {Z}_{1}^{{L}_{x}} {Z}_{2}^{{L}_{x}}} \qquad 4.8$$

In order to derive Y₃ from y₃, we consider applying the parameterized transformation functions shown in equation 4.2 to the y-coordinate equation 4.6b. We let P=(X₁, Y₁, Z₁^{L}^{ₓ}, Z₁^{L}^{_{y}}), Q=(X₂,Y₂,Z₂^{L}^{ₓ}, Z₂^{L}^{_{y}}) and R=(X₃, Y₃, Z₃^{L}^{ₓ}, Z₃^{L}^{_{y}}). Then, the projected Y₃ coordinate of the point R=P+Q can be derived as follows.

By applying the parameterized transformation functions of equation 4.2 to equation 4.6b, we get:

$$\begin{matrix}\frac{{X}_{3}}{{Z}_{3}^{{L}_{y}}} = ( \frac{\frac{{Y}_{2}}{{Z}_{2}^{{L}_{y}}} - \frac{{Y}_{1}}{{Z}_{1}^{{L}_{y}}}}{\frac{{X}_{2}}{{Z}_{2}^{{L}_{x}}} - \frac{{X}_{1}}{{Z}_{1}^{{L}_{x}}}} ) ( \frac{{X}_{1}}{{Z}_{1}^{{L}_{x}}} - \frac{{X}_{3}}{{Z}_{3}^{{L}_{x}}} ) - \frac{{Y}_{1}}{{Z}_{1}^{{L}_{y}}} \\ = ( \frac{( {Y}_{2} {Z}_{1}^{{L}_{y}} - {Y}_{1} {Z}_{2}^{{L}_{y}} ) ( {Z}_{1}^{{L}_{x}} {Z}_{2}^{{L}_{x}} )}{( {X}_{2} {Z}_{1}^{{L}_{x}} - {X}_{1} {Z}_{2}^{{L}_{x}} ) ( {Z}_{1}^{{L}_{y}} {Z}_{2}^{{L}_{y}} )} ) ( \frac{{X}_{1}}{{Z}_{1}^{{L}_{x}}} - \frac{{X}_{3}}{{Z}_{3}^{{L}_{x}}} ) - \frac{{Y}_{1}}{{Z}_{1}^{{L}_{y}}} \\ = ( \frac{U ( {Z}_{1}^{{L}_{x}} {Z}_{2}^{{L}_{x}} )}{V ( {Z}_{1}^{{L}_{y}} {Z}_{2}^{{L}_{y}} )} ) ( \frac{{X}_{1}}{{Z}_{1}^{{L}_{x}}} - \frac{{X}_{3}}{{Z}_{3}^{{L}_{x}}} ) - \frac{{Y}_{1}}{{Z}_{1}^{{L}_{y}}} .\end{matrix}$$

We then unify denominators to get.

$$\begin{matrix}\frac{{Y}_{3}}{{Z}_{3}^{{L}_{y}}} = ( \frac{U ( {Z}_{1}^{{L}_{x}} {Z}_{2}^{{L}_{x}} )}{V ( {Z}_{1}^{{L}_{y}} {Z}_{2}^{{L}_{y}} )} ) ( \frac{{X}_{1} {Z}_{3}^{{L}_{x}} - {X}_{3} {Z}_{1}^{{L}_{x}}}{{Z}_{1}^{{L}_{x}} {Z}_{3}^{{L}_{x}}} ) - \frac{{Y}_{1}}{{Z}_{1}^{{L}_{y}}} \\ = \frac{U ( {Z}_{1}^{{L}_{x}} {Z}_{2}^{{L}_{x}} ) ( {X}_{1} {Z}_{3}^{{L}_{x}} - {X}_{3} {Z}_{1}^{{L}_{x}} )}{V ( {Z}_{1}^{{L}_{y}} {Z}_{2}^{{L}_{y}} ) {Z}_{1}^{{L}_{x}} {Z}_{3}^{{L}_{x}}} - \frac{{Y}_{1}}{{Z}_{1}^{{L}_{y}}} \\ = \frac{{UZ}_{2}^{{L}_{x}} ( {X}_{1} {Z}_{3}^{{L}_{x}} - {X}_{3} {Z}_{1}^{{L}_{x}} ) - {Y}_{1} {VZ}_{2}^{{L}_{y}} {Z}_{3}^{{L}_{x}}}{V ( {Z}_{1}^{{L}_{y}} {Z}_{2}^{{L}_{y}} ) {Z}_{3}^{{L}_{x}}} \\ = \frac{{Z}_{3}^{{L}_{x}} ( {UZ}_{2}^{{L}_{x}} {X}_{1} - {Y}_{1} {VZ}_{2}^{{L}_{y}} ) - {X}_{3} {UZ}_{2}^{{L}_{x}} {Z}_{1}^{{L}_{x}}}{V ( {Z}_{1}^{{L}_{y}} {Z}_{2}^{{L}_{y}} ) {Z}_{3}^{{L}_{x}}} .\end{matrix} \\ Next , we let {Y}_{3}^{′} = {Z}_{3}^{{L}_{x}} ( {UZ}_{2}^{{L}_{x}} {X}_{1} - {Y}_{1} {VZ}_{2}^{{L}_{y}} ) - {X}_{3} {UZ}_{2}^{{L}_{x}} {Z}_{1}^{{L}_{x}} \qquad 4.9$$

so that

$$( \frac{{Y}_{3}}{{Z}_{3}^{{L}_{y}}} = \frac{{Y}_{3}^{′}}{V ( {Z}_{1}^{{L}_{y}} {Z}_{2}^{{L}_{y}} ) {Z}_{3}^{{L}_{x}}} \qquad 4.10$$

In order to choose a common Z₃ and clear the denominators of equations 4.8 and 4.10, we let R=V(Z₁^{L}^{_{y}}Z₂^{L}^{_{y}}) and then multiply the right-hand side of equation 4.8 by

$$\frac{{R ( {Z}_{1}^{{L}_{x}} {Z}_{2}^{{L}_{x}} )}^{{L}_{x} - 1}}{{R ( {Z}_{1}^{{L}_{x}} {Z}_{2}^{{L}_{x}} )}^{{L}_{x} - 1}}$$

to yield

$$\frac{{X}_{3}}{{Z}_{3}^{{L}_{x}}} = \frac{{X}_{3} {R ( {Z}_{1}^{{L}_{x}} {Z}_{2}^{{L}_{x}} )}^{{L}_{x} - 1}}{{R}^{2} {Z}_{1}^{{L}_{x}} {Z}_{2}^{{L}_{x}} {R ( {Z}_{1}^{{L}_{x}} {Z}_{2}^{{L}_{x}} )}^{{L}_{x} - 1}} = \frac{{X}_{3}^{′} {R ( {Z}_{1}^{{L}_{x}} {Z}_{2}^{{L}_{x}} )}^{{L}_{x} - 1}}{{{R}^{3} ( {Z}_{1}^{{L}_{x}} {Z}_{2}^{{L}_{x}} )}^{{L}_{x}}} \qquad 4.11$$

which can be written as:

$$\frac{{X}_{3}}{{Z}_{3}^{{L}_{x}}} = \frac{{X}_{3}^{′} {R ( {Z}_{1}^{{L}_{x}} {Z}_{2}^{{L}_{x}} )}^{{L}_{x} - 1} {R}^{3 {L}_{x} - 3}}{{( {R}^{3} ( {Z}_{1}^{{L}_{x}} {Z}_{2}^{{L}_{x}} ) )}^{{L}_{x}}} \qquad 4.12$$

Next, realizing that equation 4.10 can be written as:

$$\frac{{Y}_{3}}{{Z}_{3}^{{L}_{y}}} = \frac{{Y}_{3}^{′}}{{RZ}_{3}^{{L}_{x}}} \qquad 4.13$$

we can choose Z₃=R³(Z₁^{L}^{ₓ}Z₂^{L}^{ₓ}), which results in the conditions:

Z₃^{L}^{ₓ}=(R³(Z₁^{L}^{ₓ}Z₂^{L}^{ₓ}))^{L}^{ₓ} and Z₃^{L}^{_{y}}=(R³(Z₁^{L}^{ₓ}Z₂^{L}^{ₓ})^{L}^{_{y}} 4.14

From equation 4.12, we have Z₃^{L}^{ₓ}=(R³(Z₁^{L}^{ₓ}Z₂^{L}^{ₓ}))^{L}^{_{X}} and X₃=X₃′R(R³(Z₁^{L}^{ₓ}Z₂^{L}^{ₓ}))^{L}^{ₓ}⁻¹. In equation 4.9 for Y₃′, we can take RZ₁^{L}^{ₓ}Z₂^{L}^{ₓ}(R³(Z₁^{L}^{ₓ}Z₂^{L}^{ₓ}))^{L}^{ₓ}⁻¹ as a common factor from Z₃^{L}^{ₓ} and X₃ and rewrite equation 4.9 as:

Y₃′=(R³(Z₁^{L}^{ₓ}Z₂^{L}^{ₓ}))^{L}^{ₓ}(UZ₂^{L}^{ₓ}X₁−Y₁VZ₂^{L}^{_{y}})−X₃′R(R³(Z₁^{L}^{ₓ}Z₂^{L}^{ₓ})^{L}^{ₓ}⁻¹UZ₂^{L}^{ₓ}Z₁^{L}^{ₓ}

Y₃′=RZ₁^{L}^{ₓ}Z₂^{L}^{ₓ}(R³(Z₁^{L}^{ₓ}Z₂^{L}^{ₓ}))^{L}^{ₓ}⁻¹(R²(UZ₂^{L}^{ₓ}X₁−Y₁VZ₂^{L}^{_{y}})−X₃′U)

Letting Y₃″=R²(UZ₂^{L}^{ₓ}X₁−Y₁VZ₂^{L}^{_{y}})−X₃′U, then Y₃′=RZ₁^{L}^{ₓ}Z₂^{L}^{ₓ} (R³(Z₁^{L}^{ₓ}Z₂^{L}^{ₓ}))^{L}^{ₓ}⁻¹Y₃″. Thus, equation 4.13 can be written as:

$$\frac{{Y}_{3}}{{Z}_{3}^{{L}_{y}}} = \frac{{RZ}_{2}^{{L}_{x}} {{Z}_{1}^{{L}_{x}} ( {R}^{3} ( {Z}_{1}^{{L}_{x}} {Z}_{2}^{{L}_{x}} ) )}^{{L}_{x} - 1} {Y}_{3}^{″}}{{R ( {R}^{3} ( {Z}_{1}^{{L}_{x}} {Z}_{2}^{{L}_{x}} ) )}^{{L}_{x}}} \qquad 4.15$$

which can be simplified to:

$$\frac{{Y}_{3}}{{Z}_{3}^{{L}_{y}}} = \frac{{Z}_{1}^{{L}_{x}} {Z}_{2}^{{L}_{x}} {Y}_{3}^{″}}{{R}^{3} ( {Z}_{1}^{{L}_{x}} {Z}_{2}^{{L}_{x}} )} \qquad 4.16$$

Finally, equation 4.15 can be written as

$$\frac{{Y}_{3}}{{Z}_{3}^{{L}_{y}}} = \frac{{Z}_{1}^{{L}_{x}} {Z}_{2}^{{L}_{x}} {{Y}_{3}^{″} ( {R}^{3} ( {Z}_{1}^{{L}_{x}} {Z}_{2}^{{L}_{x}} ) )}^{{L}_{y} - 1}}{{( {R}^{3} ( {Z}_{1}^{{L}_{x}} {Z}_{2}^{{L}_{x}} ) )}^{{L}_{y}}} \qquad 4.17$$

From equations 4.12 and 4.17, we obtain the following addition formulas:

$$\begin{matrix}{X}_{3} = {X}_{3}^{′} {R ( {Z}_{1}^{{L}_{x}} {Z}_{2}^{{L}_{x}} )}^{{L}_{x} - 1} {R}^{3 {L}_{x} - 3} \\ {Y}_{3} = {Z}_{1}^{{L}_{x}} {Z}_{2}^{{L}_{x}} {{Y}_{3}^{″} ( {R}^{3} ( {Z}_{1}^{{L}_{x}} {Z}_{2}^{{L}_{x}} ) )}^{{L}_{y} - 1} \\ {Z}_{3} = {R}^{3} ( {Z}_{1}^{{L}_{x}} {Z}_{2}^{{L}_{x}} ) \\ {Z}_{3}^{{L}_{x}} = {( {R}^{3} ( {Z}_{1}^{{L}_{x}} {Z}_{2}^{{L}_{x}} ) )}^{{L}_{x}} \\ {Z}_{3}^{{L}_{y}} = {( {R}^{3} ( {Z}_{1}^{{L}_{x}} {Z}_{2}^{{L}_{x}} ) )}^{{L}_{y}} \\ where , U = {Y}_{2} {Z}_{1}^{{L}_{y}} - {Y}_{1} {Z}_{2}^{{L}_{y}} , V = {X}_{2} {Z}_{1}^{{L}_{x}} - {X}_{1} {Z}_{2}^{{L}_{x}} , \\ S = {X}_{2} {Z}_{1}^{{L}_{x}} - {X}_{1} {Z}_{2}^{{L}_{x}} , R = ( {VZ}_{1}^{{L}_{y}} {Z}_{2}^{{L}_{y}} ) \\ {X}_{3}^{′} = {{U}^{2} ( {Z}_{1}^{{L}_{x}} {Z}_{2}^{{L}_{x}} )}^{3} - {{SV}^{2} ( {Z}_{1}^{{L}_{y}} {Z}_{2}^{{L}_{y}} )}^{2} , \\ {Y}_{3}^{″} = {R}^{2} ( {UZ}_{2}^{{L}_{x}} {X}_{1} - {Y}_{1} {VZ}_{2}^{{L}_{y}} ) - {X}_{3}^{′} U\end{matrix} \} \qquad 4.18$$

### Doubling

In order to examine the doubling formulas in parameterized projective coordinates, we let P=(x₁,y₁) be a point satisfying the elliptic curve equation. The affine coordinates of the point R=(x₃,y₃)=2P are given by

$$\begin{matrix}{x}_{3} = {λ}^{2} - 2 {x}_{1} & 4.19 a \\ {y}_{3} = λ ( {x}_{1} - {x}_{3} ) - {y}_{1} \\ where λ = \frac{3 {x}_{1}^{2} + a}{2 {y}_{1}} . & 4.19 b\end{matrix}$$

The parameterized transformation functions shown in equations 4.2 are used to obtain the parameterized projected coordinates (X₃, Y₃, Z₃^{L}^{ₓ}, Z₃^{L}^{_{y}}) of the point R according to the above equations. The derivations of X₃ and Y₃ are present as follows.

In order to examine the derivation of the parameterized projective coordinates of X₃, we consider applying the parameterized transformation functions shown in equation 4.2 to the x-coordinate equation 4.19a. We let P=R=(X₁, Y₁, Z₁^{L}^{ₓ}, Z₁^{L}^{_{y}}) and R=(X₃, Y₃, Z₃^{L}^{ₓ}, Z₃^{L}^{_{y}}), then the projected X₃ coordinate of the point R=2P can be derived as follows:

By applying the parameterized transformation equation 4.2 to equation 4.19a, we obtain:

$$\begin{matrix}\frac{{X}_{3}}{{Z}_{3}^{{L}_{x}}} = {( \frac{3 \frac{{X}_{1}^{2}}{{Z}_{1}^{2 {L}_{x}}} + a}{2 \frac{{Y}_{1}}{{Z}_{1}^{{L}_{y}}}} )}^{2} - 2 \frac{{X}_{1}}{{Z}_{1}^{{L}_{x}}} \\ = {( \frac{\frac{3 {X}_{1}^{2} + {aZ}_{1}^{2 {L}_{x}}}{{Z}_{1}^{2 {L}_{x}}}}{2 \frac{{Y}_{1}}{{Z}_{1}^{{L}_{y}}}} )}^{2} - 2 \frac{{X}_{1}}{{Z}_{1}^{{L}_{x}}} \\ = {( \frac{( 3 {X}_{1}^{2} + {aZ}_{1}^{2 {L}_{x}} ) {Z}_{1}^{{L}_{y}}}{2 {Z}_{1}^{2 {L}_{x}} {Y}_{1}} )}^{2} - 2 \frac{{X}_{1}}{{Z}_{1}^{{L}_{x}}} .\end{matrix}$$

Letting W=3X₁²+aZ₁^{2L}^{ₓ}, then we have

$$\begin{matrix}\frac{{X}_{3}}{{Z}_{3}^{{L}_{x}}} = \frac{{( {WZ}_{1}^{{L}_{y}} )}^{2}}{{( 2 {Z}_{1}^{2 {L}_{x}} {Y}_{1} )}^{2}} - 2 \frac{{X}_{1}}{{Z}_{1}^{{L}_{x}}} \\ = \frac{{( {WZ}_{1}^{{L}_{y}} )}^{2} - 8 {X}_{1} {Z}_{1}^{3 {L}_{x}} {Y}_{1}^{2}}{{( 2 {Z}_{1}^{2 {L}_{x}} {Y}_{1} )}^{2}} .\end{matrix}$$

Letting S=2Z₁^{2L}^{ₓ}, then

$$\frac{{X}_{3}}{{Z}_{3}^{{L}_{x}}} = \frac{{( {WZ}_{1}^{{L}_{y}} )}^{2} - 4 {SX}_{1} {Y}_{1} {Z}_{1}^{{L}_{x}}}{{S}^{2}} ,$$

and letting X₃′=(WZ₁^{L}^{_{y}})²−4SX₁Y₁Z₁^{L}^{ₓ}, we obtain

$$\frac{{X}_{3}}{{Z}_{3}^{{L}_{x}}} = \frac{{X}_{3}^{′}}{{S}^{2}} \qquad 4.20$$

Similarly, in order to derive the parameterized projective coordinate Y₃, we consider applying the parameterized transformation functions shown in equation 4.2 to the y-coordinate equation 4.19b. We let P=(X₃, Y₃, Z₁^{L}^{ₓ}, Z₁^{L}^{_{y}}) and R=(X₃, Y₃, Z₃^{L}^{ₓ}, Z₃^{L}^{_{y}}). Then the projected Y₃ coordinate of the point R=2P can be derived as follows:

By applying the parameterized transformation functions of equation 4.2 to equation 4.19b, we obtain:

$$\begin{matrix}\frac{{Y}_{3}}{{Z}_{3}^{{L}_{y}}} = ( \frac{3 \frac{{X}_{1}^{2}}{{Z}_{1}^{2 {L}_{x}}} + a}{2 \frac{{Y}_{1}}{{Z}_{1}^{{L}_{y}}}} ) ( \frac{{X}_{1}}{{Z}_{1}^{{L}_{x}}} - \frac{{X}_{3}}{{Z}_{3}^{{L}_{x}}} ) - \frac{{Y}_{1}}{{Z}_{1}^{{L}_{y}}} \\ = ( \frac{( {WZ}_{1}^{{L}_{y}} )}{( 2 {Z}_{1}^{2 {L}_{x}} {Y}_{1} )} ) ( \frac{{X}_{1}}{{Z}_{1}^{{L}_{x}}} - \frac{{X}_{3}}{{Z}_{3}^{{L}_{x}}} ) - \frac{{Y}_{1}}{{Z}_{1}^{{L}_{y}}} .\end{matrix}$$

Unifying the denominators results in:

$$\begin{matrix}\frac{{Y}_{3}}{{Z}_{3}^{{L}_{y}}} = \frac{( {WZ}_{1}^{{L}_{y}} ) ( {X}_{1} {Z}_{3}^{{L}_{x}} - {X}_{3} {Z}_{1}^{{L}_{x}} )}{2 {Z}_{1}^{3 {L}_{x}} {Y}_{1} {Z}_{3}^{{L}_{x}}} - \frac{{Y}_{1}}{{Z}_{1}^{{L}_{y}}} \\ = \frac{{Z}_{1}^{{L}_{y}} ( {WZ}_{1}^{{L}_{y}} ) ( {X}_{1} {Z}_{3}^{{L}_{x}} - {X}_{3} {Z}_{1}^{{L}_{x}} ) - 2 {Y}_{1} {Z}_{1}^{3 {L}_{x}} {Y}_{1} {Z}_{3}^{{L}_{x}}}{2 {Z}_{1}^{3 {L}_{x}} {Z}_{1}^{{L}_{y}} {Y}_{1} {Z}_{3}^{{L}_{x}}}\end{matrix}$$

which can be rearranged to obtain

$$\frac{{Y}_{3}}{{Z}_{3}^{{L}_{y}}} = \frac{{Z}_{3}^{{L}_{x}} ( {WX}_{1} {Z}_{1}^{2 {L}_{y}} - {SZ}_{1}^{{L}_{x}} {Y}_{1} ) - {X}_{3} {WZ}_{1}^{2 {L}_{y}} {Z}_{1}^{{L}_{x}}}{{SZ}_{1}^{{L}_{x}} {Z}_{1}^{{L}_{y}} {Z}_{3}^{{L}_{x}}}$$

Letting Y₃′=Z₃^{L}^{ₓ}(WX₁Z₁^{2L}^{_{y}}−SZ₁^{L}^{ₓ}Y₁)−X₃WZ₁^{2L}^{_{y}}Z₁^{L}^{ₓ} 4.21

then

$$\frac{{Y}_{3}}{{Z}_{3}^{{L}_{y}}} = \frac{{Y}_{3}^{′}}{{SZ}_{1}^{{L}_{x}} {Z}_{1}^{{L}_{y}} {Z}_{3}^{{L}_{x}}} \qquad 4.22$$

To choose a common Z₃ and clear the denominators of equations 4.20 and 4.22, we multiply the right-hand side of equation 4.20 by

$$\frac{{SZ}_{1}^{{L}_{x}} {Z}_{1}^{{L}_{y}}}{{SZ}_{1}^{{L}_{x}} {Z}_{1}^{{L}_{y}}}$$

to obtain

$$\frac{{X}_{3}}{{Z}_{3}^{{L}_{x}}} = \frac{{X}_{3}^{′} {SZ}_{1}^{{L}_{x}} {Z}_{1}^{{L}_{y}}}{{S}^{3} {Z}_{1}^{{L}_{x}} {Z}_{1}^{{L}_{y}}}$$

which can be written as:

$$\frac{{X}_{3}}{{Z}_{3}^{{L}_{x}}} = \frac{{X}_{3}^{′} {SZ}_{1}^{{L}_{x}} {{Z}_{1}^{{L}_{y}} ( {S}^{3} {Z}_{1}^{{L}_{x}} {Z}_{1}^{{L}_{y}} )}^{{L}_{x} - 1}}{{( {S}^{3} {Z}_{1}^{{L}_{x}} {Z}_{1}^{{L}_{y}} )}^{{L}_{x}}} \qquad 4.23$$

Next, we choose Z₃=S³Z₁^{L}^{ₓ}Z₁^{L}^{_{y}} which yields:

Z₃^{L}^{ₓ}=(S³Z₁^{L}^{ₓ}Z₁^{L}^{_{y}})^{L}^{ₓ} and Z₃^{L}^{_{y}}=(S³Z₁^{L}^{ₓ}Z₁^{L}^{_{y}})^{L}^{_{y}} 4.24

From equation 4.23, we have Z₃^{L}^{ₓ}=(S³Z₁^{L}^{ₓ}Z₁^{L}^{_{y}})^{L}^{ₓ} and X₃=X₃′SZ₁^{L}^{ₓ}Z₁^{L}^{_{y}}(S³Z₁^{L}^{ₓ}Z₁^{L}^{_{y}})^{L}^{ₓ}⁻¹. In the y-coordinate equation for Y₃′, i.e., equation 4.21, we can take SZ₁^{L}^{ₓ}Z₁^{L}^{_{y}}(S³Z₁^{L}^{ₓ}Z₁^{L}^{_{y}})^{L}^{ₓ}⁻¹ as a common factor from Z₃^{L}^{ₓ} and X₃ and rewrite equation 4.21 as:

Y₃′=SZ₁^{L}^{ₓ}Z₁^{L}^{_{y}}(S³Z₁^{L}^{ₓ}Z₁^{L}^{_{y}})^{L}^{ₓ}⁻¹(S²(WX₁Z₁^{2L}^{_{y}}−SZ₁^{L}^{ₓ}Y₁)−X₃′WZ₁^{2L}^{_{y}}Z₁^{L}^{ₓ}).

Letting Y₃″=S²(WX₁Z₁^{2L}^{_{y}}−SZ₁^{L}^{ₓ}Y₁)−X₃′WZ₁^{2L}^{_{y}}Z₁^{L}^{ₓ}, then Y₃′=SZ₁^{L}^{ₓ}Z₁^{L}^{_{y}}(S³Z₁^{L}^{ₓ}Z₁^{L}^{_{y}})^{L}^{ₓ}⁻¹Y₃″.
Therefore, the equation 4.22 can be written as:

$$\frac{{Y}_{3}}{{Z}_{3}^{{L}_{y}}} = \frac{{SZ}_{1}^{{L}_{x}} {{Z}_{1}^{{L}_{y}} ( {S}^{3} {Z}_{1}^{{L}_{x}} {Z}_{1}^{{L}_{y}} )}^{{L}_{x} - 1} {Y}_{3}^{″}}{{SZ}_{1}^{{L}_{x}} {{Z}_{1}^{{L}_{y}} ( {S}^{3} {Z}_{1}^{{L}_{x}} {Z}_{1}^{{L}_{y}} )}^{{L}_{x}}} = \frac{{Y}_{3}^{″}}{{S}^{3} {Z}_{1}^{{L}_{x}} {Z}_{1}^{{L}_{y}}} \qquad 4.25$$

Finally, equation 4.25 can be written as:

$$\frac{{Y}_{3}}{{Z}_{3}^{{L}_{y}}} = \frac{{{Y}_{3}^{″} ( {S}^{3} {Z}_{1}^{{L}_{x}} {Z}_{1}^{{L}_{y}} )}^{{L}_{y} - 1}}{{( {S}^{3} {Z}_{1}^{{L}_{x}} {Z}_{1}^{{L}_{y}} )}^{{L}_{y}}} \qquad 4.26$$

From equations 4.23 and 4.26, we obtain the following set of doubling formulas:

$$\begin{matrix}{X}_{3} = {X}_{3}^{′} {SZ}_{1}^{{L}_{x}} {{Z}_{1}^{{L}_{y}} ( {S}^{3} {Z}_{1}^{{L}_{x}} {Z}_{1}^{{L}_{y}} )}^{{L}_{x} - 1} \\ {Y}_{3} = {{Y}_{3}^{″} ( {S}^{3} {Z}_{1}^{{L}_{x}} {Z}_{1}^{{L}_{y}} )}^{{L}_{y} - 1} \\ {Z}_{3} = {S}^{3} {Z}_{1}^{{L}_{x}} {Z}_{1}^{{L}_{x}} \\ {Z}_{3}^{{L}_{x}} = {( {S}^{3} {Z}_{1}^{{L}_{x}} {Z}_{1}^{{L}_{x}} )}^{{L}_{x}} \\ {Z}_{3}^{{L}_{y}} = {( {S}^{3} {Z}_{1}^{{L}_{x}} {Z}_{1}^{{L}_{x}} )}^{{L}_{y}} \\ Where , W = 3 {X}_{1}^{2} + {aZ}_{1}^{2 {L}_{x}} , S = 2 {Z}_{1}^{2 {L}_{x}} {Y}_{1} \\ {X}_{3}^{′} = {( {WZ}_{1}^{{L}_{y}} )}^{2} - 4 {SX}_{1} {Y}_{1} {Z}_{1}^{{L}_{x}} \\ {Y}_{3}^{″} = {S}^{2} ( {WX}_{1} {Z}_{1}^{2 {L}_{y}} - {SZ}_{1}^{{L}_{x}} {Y}_{1} ) - {X}_{3}^{′} {WZ}_{1}^{2 {L}_{y}} {Z}_{1}^{{L}_{x}}\end{matrix} \} \qquad 4.27$$

### Optimized Addition

The addition formulas of 4.18 are the most general formulas that can operate without any restriction in the values of the projecting parameters Lₓ and L_{y}. However, their computation complexity can be reduced by reproducing, these formulas, taking Z₁ and Z₂ as common factors in each equation (whenever it is possible), and simplifying the resultant formulas through the elimination of unnecessary terms. This results in the existence of terms such as Z₁^{L}^{_{y}}^{-L}^{ₓ}, in which the exponent is a relation between Lₓ and L_{y}. The derivation of optimized addition formulas is given below.

In order to derive the parameterized projective coordinates of equation 4.6a (for X₃), we consider applying the parameterized transformation functions shown in equation 4.2 to the x-coordinate equation 4.6a. Letting P=(X₁,Y₁,Z₁^{L}^{ₓ},Z₁^{L}^{_{y}}), Q=(X₂, Y₂,Z₂^{L}^{ₓ},Z₂^{L}^{_{y}}) and R=(X₃,Y₃,Z₃^{L}^{ₓ}, Z₃^{L}^{_{y}}) then the projected X₃ coordinate of the point R=P+Q can be derived as follows:

By applying the parameterized transformation functions of equation 4.2 to equation 4.6a, we obtain:

$$\frac{{X}_{3}}{{Z}_{3}^{{L}_{x}}} = {( \frac{\frac{{Y}_{2}}{{Z}_{2}^{{L}_{y}}} - \frac{{Y}_{1}}{{Z}_{1}^{{L}_{y}}}}{\frac{{X}_{2}}{{Z}_{2}^{{L}_{x}}} - \frac{{X}_{1}}{{Z}_{1}^{{L}_{x}}}} )}^{2} - \frac{{X}_{1}}{{Z}_{1}^{{L}_{x}}} - \frac{{X}_{2}}{{Z}_{2}^{{L}_{x}}}$$

Unifying denominators results in

$$= {( \frac{\frac{{Y}_{2} {Z}_{1}^{{L}_{y}} - {Y}_{1} {Z}_{2}^{{L}_{y}}}{{Z}_{1}^{{L}_{y}} {Z}_{2}^{{L}_{y}}}}{\frac{{X}_{2} {Z}_{1}^{{L}_{x}} - {X}_{1} {Z}_{2}^{{L}_{x}}}{{Z}_{1}^{{L}_{x}} {Z}_{2}^{{L}_{x}}}} )}^{2} - \frac{{X}_{1} {Z}_{2}^{{L}_{x}} + {X}_{2} {Z}_{1}^{{L}_{x}}}{{Z}_{1}^{{L}_{x}} {Z}_{2}^{{L}_{x}}} \\ = {( \frac{( {Y}_{2} {Z}_{1}^{{L}_{y}} - {Y}_{1} {Z}_{2}^{{L}_{y}} ) ( {Z}_{1}^{{L}_{x}} {Z}_{2}^{{L}_{x}} )}{( {X}_{2} {Z}_{1}^{{L}_{x}} - {X}_{1} {Z}_{2}^{{L}_{x}} ) ( {Z}_{1}^{{L}_{y}} {Z}_{2}^{{L}_{y}} )} )}^{2} - \frac{{X}_{1} {Z}_{2}^{{L}_{x}} + {X}_{2} {Z}_{1}^{{L}_{x}}}{{Z}_{1}^{{L}_{x}} {Z}_{2}^{{L}_{x}}} .$$

Next, we let U=Y₂Z₁^{L}^{_{y}}−Y₁Z₂^{L}^{_{y}}, V=X₂Z₁^{L}^{ₓ}−X₁Z₂^{L}^{ₓ} and S=X₂Z₁^{L}^{ₓ}+X₁Z₂^{L}^{ₓ},so that

$$\frac{{X}_{3}}{{Z}_{3}^{{L}_{x}}} = \frac{{U}^{2}}{{{V}^{2} ( {Z}_{1}^{{L}_{y} - {L}_{x}} {Z}_{2}^{{L}_{y} - {L}_{x}} )}^{2}} - \frac{S}{{Z}_{1}^{{L}_{x}} {Z}_{2}^{{L}_{x}}} \\ = \frac{{U}^{2} {Z}_{1}^{{L}_{x}} {Z}_{2}^{{L}_{x}} - {{SV}^{2} ( {Z}_{1}^{{L}_{y} - {L}_{x}} {Z}_{2}^{{L}_{y} - {L}_{x}} )}^{2}}{{{V}^{2} ( {Z}_{1}^{{L}_{y} - {L}_{x}} {Z}_{2}^{{L}_{y} - {L}_{x}} )}^{2} {Z}_{1}^{{L}_{x}} {Z}_{2}^{{L}_{x}}}$$

Letting X₃′=U²Z₁^{L}^{ₓ}Z₂^{L}^{ₓ}−SV²(Z₁^{L}^{_{y}}^{-L}^{ₓ}Z₂^{L}^{_{y}}^{-L}^{ₓ})² 5.7

then:

$$\frac{{X}_{3}}{{Z}_{3}^{{L}_{x}}} = \frac{{X}_{3}^{′}}{{{V}^{2} ( {Z}_{1}^{{L}_{y} - {L}_{x}} {Z}_{2}^{{L}_{y} - {L}_{x}} )}^{2} {Z}_{1}^{{L}_{x}} {Z}_{2}^{{L}_{x}}} \qquad 5.8$$

Similarly, in order to derive the parameterized projective coordinates of equation 4.6b (for Y₃), we consider applying the parameterized transformation functions shown in equation 4.2 to the y-coordinate equation 4.6b. We let P=(X₁,Y₁,Z₁^{L}^{ₓ},Z₁^{L}^{_{y}}), Q=(X₂,Y₂,Z₂^{L}^{ₓ},Z₂^{L}^{_{y}}) and R=(X₃,Y₃,Z₃^{L}^{ₓ},Z₃^{L}^{_{y}}), then the projected Y₃ coordinate of the point R=P+Q can be derived as follows.

By applying the parameterized transformation functions of equation 4.2 to equation 4.6b, we obtain:

$$\begin{matrix}\frac{{Y}_{3}}{{Z}_{3}^{{L}_{y}}} = ( \frac{\frac{{Y}_{2}}{{Z}_{2}^{{L}_{y}}} - \frac{{Y}_{1}}{{Z}_{1}^{{L}_{y}}}}{\frac{{X}_{2}}{{Z}_{2}^{{L}_{x}}} - \frac{{X}_{1}}{{Z}_{1}^{{L}_{x}}}} ) ( \frac{{X}_{1}}{{Z}_{1}^{{L}_{x}}} - \frac{{X}_{2}}{{Z}_{3}^{{L}_{x}}} ) - \frac{{Y}_{1}}{{Z}_{1}^{{L}_{y}}} \\ = ( \frac{( {Y}_{2} {Z}_{1}^{{L}_{y}} - {Y}_{1} {Z}_{2}^{{L}_{y}} )}{( {X}_{2} {Z}_{1}^{{L}_{x}} - {X}_{1} {Z}_{2}^{{L}_{x}} ) ( {Z}_{1}^{{L}_{y} - {L}_{x}} {Z}_{2}^{{L}_{y} - {L}_{x}} )} ) ( \frac{{X}_{1}}{{Z}_{1}^{{L}_{x}}} - \frac{{X}_{3}}{{Z}_{3}^{{L}_{x}}} ) - \frac{{Y}_{1}}{{Z}_{1}^{{L}_{y}}} \\ = ( \frac{U}{V ( {Z}_{1}^{{L}_{y} - {L}_{x}} {Z}_{2}^{{L}_{y} - {L}_{x}} )} ) ( \frac{{X}_{1}}{{Z}_{1}^{{L}_{x}}} - \frac{{X}_{3}}{{Z}_{3}^{{L}_{x}}} ) - \frac{{Y}_{1}}{{Z}_{1}^{{L}_{y}}}\end{matrix}$$

Unifying denominators results in:

$$\begin{matrix}\frac{{Y}_{3}}{{Z}_{3}^{{L}_{y}}} = ( \frac{U}{V ( {Z}_{1}^{{L}_{y} - {L}_{x}} {Z}_{2}^{{L}_{y} - {L}_{x}} )} ) ( \frac{{X}_{1} {Z}_{3}^{{L}_{x}} - {X}_{3} {Z}_{1}^{{L}_{x}}}{{Z}_{1}^{{L}_{x}} {Z}_{3}^{{L}_{x}}} ) - \frac{{Y}_{1}}{{Z}_{1}^{{L}_{y}}} \\ = \frac{U ( {X}_{1} {Z}_{3}^{{L}_{x}} - {X}_{3} {Z}_{1}^{{L}_{x}} )}{{VZ}_{1}^{{L}_{y}} {Z}_{2}^{{L}_{y} - {L}_{x}} {Z}_{3}^{{L}_{x}}} - \frac{{Y}_{1}}{{Z}_{1}^{{L}_{y}}} \\ = \frac{U ( {X}_{1} {Z}_{3}^{{L}_{x}} - {X}_{3} {Z}_{1}^{{L}_{x}} ) - {Y}_{1} {VZ}_{2}^{{L}_{y} - {L}_{x}} {Z}_{3}^{{L}_{x}}}{{VZ}_{1}^{{L}_{y}} {Z}_{2}^{{L}_{y} - {L}_{x}} {Z}_{3}^{{L}_{x}}} \\ = \frac{{Z}_{3}^{{L}_{x}} ( {UX}_{1} - {Y}_{1} {VZ}_{2}^{{L}_{y} - {L}_{x}} ) - {X}_{3} {UZ}_{1}^{{L}_{x}}}{{VZ}_{1}^{{L}_{y}} {Z}_{2}^{{L}_{y} - {L}_{x}} {Z}_{3}^{{L}_{x}}} .\end{matrix}$$

Letting Y₃′=Z₃^{L}^{ₓ}(UX₁−Y₁VZ₂^{L}^{_{y}}^{-L}^{ₓ})−X₃UZ₁^{L}^{ₓ} 5.9

results in:

$$\frac{{Y}_{3}}{{Z}_{3}^{{L}_{y}}} = \frac{{Y}_{3}^{′}}{{VZ}_{1}^{{L}_{y}} {Z}_{2}^{{L}_{y} - {L}_{x}} {Z}_{3}^{{L}_{x}}} \qquad 5.10$$

To choose a common Z₃ and clear the denominators of equation 5.8 and equation 5.10, we let R=V(Z₁^{L}^{_{y}}Z₂^{L}^{_{y}}) and multiply the right-hand side of equation 5.8 by

$$\frac{{Z}_{1}^{{L}_{x}} {Z}_{2}^{{L}_{x}}}{{Z}_{1}^{{L}_{x}} {Z}_{2}^{{L}_{x}}}$$

to obtain

$$\frac{{X}_{3}}{{Z}_{3}^{{L}_{x}}} = \frac{{X}_{3}^{′} {Z}_{1}^{{L}_{x}} {Z}_{2}^{{L}_{x}}}{{{V}^{2} ( {Z}_{1}^{{L}_{y}} {Z}_{2}^{{L}_{y}} )}^{2}} = \frac{{X}_{3}^{′} {Z}_{1}^{{L}_{x}} {Z}_{2}^{{L}_{x}}}{{R}^{2}} \qquad 5.11$$

Next, we multiply the right-hand side of equation 5.10 by

$$\frac{{Z}_{2}^{{L}_{x}}}{{Z}_{2}^{{L}_{x}}}$$

to yield

$$\frac{{Y}_{3}}{{Z}_{3}^{{L}_{y}}} = \frac{{Y}_{3}^{′} {Z}_{2}^{{L}_{x}}}{V {Z}_{1}^{{L}_{y}} {Z}_{2}^{{L}_{y}} {Z}_{3}^{{L}_{x}}} = \frac{{Y}_{3}^{′} {Z}_{2}^{{L}_{x}}}{R {Z}_{3}^{{L}_{x}}} \qquad 5.12$$

Equation 5.12 has an extra R in its denominator. In order to clear this R, we have to extract an R from Y₃′ to cancel it with the R in the denominator. Thus, we multiply the right-hand side of equation 5.11 by

$$\frac{R}{R}$$

to obtain

$$\frac{{X}_{3}}{{Z}_{3}^{{L}_{x}}} = \frac{{X}_{3}^{′} {Z}_{1}^{{L}_{x}} {Z}_{2}^{{L}_{x}} R}{{R}^{3}} \qquad 5.13$$

Choosing Z₃=R³ results in:

Z₃^{L}^{ₓ}=(R³)^{L}^{ₓ} and Z₃^{L}^{_{y}}=(R³)^{L}^{_{y}} 5.14

which allows us to write equation 5.13 as:

$$\frac{{X}_{3}}{{Z}_{3}^{{L}_{x}}} = \frac{{X}_{3}^{′} {Z}_{1}^{{L}_{x}} {Z}_{2}^{{L}_{x}} R {R}^{3 {L}_{x} - 3}}{{R}^{3 {L}_{x}}} \qquad 5.15$$

From equation 5.15, we have Z₃^{L}^{ₓ}=R^{3L}^{ₓ} and X₃=X₃′Z₁^{L}^{ₓ}Z₂^{L}^{ₓ}R^{3L}^{ₓ}⁻². In the equation for Y₃′, i.e., equation 5.9, we can take R^{3L}^{ₓ}⁻² as a common factor from Z₃^{L}^{ₓ} and X₃ and rewrite equation 5.9 as:

$$\begin{matrix}{Y}_{3}^{′} = {R}^{3 {L}_{x}} ( U {X}_{1} - {Y}_{1} V {Z}_{2}^{{L}_{y} - {L}_{x}} ) - {X}_{3}^{′} {Z}_{1}^{{L}_{x}} {Z}_{2}^{{L}_{x}} {R}^{3 {L}_{x} - 2} U {Z}_{1}^{{L}_{x}} \\ = {R}^{3 {L}_{x} - 2} ( {R}^{2} ( U {X}_{1} - {Y}_{1} V {Z}_{2}^{{L}_{y} - {L}_{x}} ) - {X}_{3}^{′} {Z}_{1}^{{L}_{x}} {Z}_{2}^{{L}_{x}} U {Z}_{1}^{{L}_{x}} ) .\end{matrix}$$

Letting Y₃″=R²(UX₁−Y₁VZ₂^{L}^{_{y}}^{-L}^{ₓ})−X₃′Z₁^{L}^{ₓ}Z₂^{L}^{ₓ}UZ₁^{L}^{ₓ}, then Y₃′=R^{3L}^{ₓ}⁻²Y₃″. Therefore, equation 5.12 can be written as:

$$\frac{{Y}_{3}}{{Z}_{3}^{{L}_{y}}} = \frac{{R}^{3 {L}_{x} - 2} {Y}_{3}^{″} {Z}_{2}^{{L}_{x}}}{R {R}^{3 {L}_{x}}} = \frac{{R}^{3 {L}_{x} - 3} {Y}_{3}^{″} {Z}_{2}^{{L}_{x}}}{{R}^{3 {L}_{x}}} = \frac{{Y}_{3}^{″} {Z}_{2}^{{L}_{x}}}{{R}^{3}} \qquad 5.16$$

Finally, equation 5.16 can be written as:

$$\frac{{Y}_{3}}{{Z}_{3}^{{L}_{y}}} = \frac{{Y}_{3}^{″} {{Z}_{2}^{{L}_{x}} ( {R}^{3} )}^{{L}_{y} - 1}}{{R}^{3 {L}_{y}}} \qquad 5.17$$

From equations 5.15 and 5.17, we obtain the following set of addition formulas:

$$\begin{matrix}{X}_{3} = {X}_{3}^{′} {Z}_{1}^{{L}_{x}} {Z}_{2}^{{L}_{x}} {R}^{3 {L}_{x} - 2} \\ {Y}_{3} = {Y}_{3}^{″} {{Z}_{2}^{{L}_{x}} ( {R}^{3} )}^{{L}_{y} - 1} \\ {Z}_{3} = {R}^{3} \\ {Z}_{3}^{{L}_{x}} = {R}^{3 {L}_{x}} \\ {Z}_{3}^{{L}_{y}} = {R}^{3 {L}_{y}} \\ where , \\ U = {Y}_{2} {Z}_{1}^{{L}_{y}} - {Y}_{1} {Z}_{2}^{{L}_{y}} , \\ V = {X}_{2} {Z}_{1}^{{L}_{x}} - {X}_{1} {Z}_{2}^{{L}_{x}} , \\ S = {X}_{2} {Z}_{1}^{{L}_{x}} + {X}_{1} {Z}_{2}^{{L}_{x}} , \\ R = ( V {Z}_{1}^{{L}_{y}} {Z}_{2}^{{L}_{y}} ) \\ {X}_{3}^{′} = {U}^{2} {Z}_{1}^{{L}_{x}} {Z}_{2}^{{L}_{x}} - S {{V}^{2} ( {Z}_{1}^{{L}_{y} - {L}_{x}} {Z}_{2}^{{L}_{y} - {L}_{x}} )}^{2} , \\ {Y}_{3}^{″} = {R}^{2} ( U {X}_{1} - {Y}_{1} V {Z}_{2}^{{L}_{y} - {L}_{x}} ) - {X}_{3}^{′} U {Z}_{1}^{2 {L}_{x}} {Z}_{2}^{{L}_{x}}\end{matrix} \} \qquad 5.18$$

Selection of Lₓ and L_{y} values plays a prominent role in optimizing the computation complexity of the addition formulas of 5.18. If Lₓ and L_{y} are selected in a way that causes the expression (L_{y}−Lₓ) to be negative, then we need a field inversion operation to calculate the terms Z₁^{L}^{_{y}}^{-L}^{ₓ} and Z₂^{L}^{_{y}}^{-L}^{ₓ}. In other words, existence of the terms Z₁^{L}^{_{y}}^{-L}^{ₓ} and Z₂^{L}^{_{y}}^{-L}^{ₓ} in the formulas of 5.18 may cause the need for inversion operations if we have a negative power; i.e., if L_{y}−Lₓ<0. However, this problem can be solved by restricting the selection of Lₓ and L_{y} to the rule: L_{y}−Lₓ≧0. When L_{y}=Lₓ then, L_{y}−Lₓ=0 and we get the optimal PPC addition formulas of 5.18.

### Optimized Doubling Formulas

Doubling formulas 4.27 are the most general formulas that can operate without any restriction in the values of the projecting parameters Lₓ and L_{y}. However, their computation complexity can be reduced by reproducing these formulas with Z₁ as a common factor in each equation (whenever it is possible) and simplifying the resultant formulas through elimination of the unnecessary terms. This results in the existence of terms such as Z₁^{L}^{_{y}}^{-L}^{ₓ}, in which the exponent is a relation between Lₓ and L_{y}. Following a similar mathematical procedure to that shown above in the derivations of the respective parameterized projective coordinates, we obtain the following doubling formulas:

$$\begin{matrix}{X}_{3} = {X}_{3}^{′} S {{Z}_{1}^{{L}_{y}} ( {S}^{3} {Z}_{1}^{{L}_{y}} )}^{{L}_{x} - 1} \\ {Y}_{3} = {{Y}_{3}^{″} ( {S}^{3} {Z}_{1}^{{L}_{y}} )}^{{L}_{y} - 1} \\ {Z}_{3} = {S}^{3} {Z}_{1}^{{L}_{x}} \\ {Z}_{3}^{{L}_{x}} = {( {S}^{3} {Z}_{1}^{{L}_{x}} )}^{{L}_{x}} \\ {Z}_{3}^{{L}_{y}} = {( {S}^{3} {Z}_{1}^{{L}_{x}} )}^{{L}_{y}} \\ Where , \\ W = 3 {X}_{1}^{2} + a {Z}_{1}^{2 {L}_{x}} , \\ S = 2 {Z}_{1}^{{L}_{x}} {Y}_{1} \\ {X}_{3}^{′} = {( W {Z}_{1}^{{L}_{y} - {L}_{x}} )}^{2} - 4 S {X}_{1} {Y}_{1} \\ {Y}_{3}^{″} = {S}^{2} ( W {X}_{1} {Z}_{1}^{2 ( {L}_{y} - {L}_{x} )} - S {Y}_{1} ) - {X}_{3}^{′} W {Z}_{1}^{2 ( {L}_{y} - {L}_{x} )} {Z}_{1}^{{L}_{x}}\end{matrix} \} \qquad 5.27$$

As with addition, selection of Lₓ and L_{y} values plays a prominent role in optimizing the computation complexity of the doubling formulas of 5.27. If Lₓ and L_{y} are selected in a way that causes the expression (L_{y}−Lₓ) to be negative, then we need a field inversion operation to calculate the term Z₁^{L}^{_{y}}^{-L}^{ₓ}. In other words, existence of the term Z₁^{L}^{_{y}}^{-L}^{ₓ} in the formulas of 5.27 may cause the need for an inversion operation if we have a negative power; i.e., if L_{y}−Lₓ<0. However, this problem can be solved by restricting the selection of Lₓ and L_{y} to the rule: L_{y}−Lₓ≧0. When L_{y}=Lₓ, then L_{y}−Lₓ=0, and we get the optimal PPC doubling formulas, as can be observed in 5.27.

In order to examine runtime randomization of parameterized projective coordinate systems, we note that elliptic curve scalar multiplication, KP, can be computed using any of Algorithms 1 through 5. As discussed above, using projective coordinates is strongly recommended to avoid the field inversion operations (or, equivalently, division) while computing KP.

Many countermeasures against differential power analysis attacks rely on randomized projective coordinates. However, all of these countermeasures depend upon a predetermined single or a small set of projective coordinate systems that are decided at the design stage. The method of the present invention uses runtime randomization of parameterized projective coordinates (RRPPC).

A common property of the RRPPC countermeasures is that the projective coordinate system is selected by the crypto-device at random, i.e., it is not predetermined. Variations of the method of the present invention differ in the manner of selecting Lₓ and L_{y} values. Three countermeasure implementations based on the RRPPC are presented below. However, it should be noted that the proposed countermeasures can work with any scalar multiplication algorithm.

The first countermeasure is based on the unrestricted selection of Lₓ and L_{y} values. Therefore, Lₓ and L_{y} can be selected randomly in the range of integers from 1 to N. This countermeasure uses the PPC addition formulas of 4.18 and the PPC doubling formulas of 4.27. The steps of the first countermeasure are shown below in Algorithm 6.1 and can be summarized as follows:

Step 1: randomly select Lₓ value in the range from 1 to N;

Step 2: randomly select L_{y} value in the range from 1 to N;

Step 3: project the base point P to the point \tilde{P} using the parameterized transformation functions of equation 4.2. The projected point \tilde{P} is then used as input to the scalar multiplication algorithm. The output of the scalar multiplication algorithm is the point Q; and

Step 4: Since the scalar multiplication uses the PPC formulas for both addition and doubling operations, the resultant point, Q, will be generated in the PPC representation. Step 4 brings the point Q back to the affine coordinates representation by applying the reverse transformation functions (RRPPC⁻¹) of the transformation functions of equation 4.2.

Algorithm 6.1: Countermeasure 1

| | |
|---|---|
| INPUT | K,P |
| OUTPUT | KP |

```
1.  Lₓ=Rand(1..N)
2.  L_{y}=Rand(1..N)
3.  P =RRPPC(P)
4.  Any scalar multiplication algorithm
        For ADD Use Formulas 4.18
        For DBL Use Formulas 4.27
    Q←Output of the algorithm
5.  R=RRPPC⁻¹(Q)
return (R)
```

The second countermeasure is based on the optimized PPC addition and doubling formulas of equations 5.18 and 5.27 in which Lₓ and L_{y} are selected according to the rule: L_{y}−Lₓ≧0. This countermeasure uses the optimized PPC addition formulas of 5.18 and the optimized PPC doubling formulas of 5.27. The steps of the second countermeasure are shown in Algorithm 6.2 below and can be summarized as follows:

Step 1: randomly select Lₓ value in the range from 1 to N;

Step 2: randomly select L_{y} value in the range from 1 to N such that L_{y}−Lₓ≧0;

Step 3: project the base point P to the point \tilde{P} using the parameterized transformation functions of equation 4.2; The projected point \tilde{P} is then used as input to the scalar multiplication algorithm. The output of the scalar multiplication algorithm is the point Q.

Step 4: since the scalar multiplication uses the optimized PPC formulas for both addition and doubling operations, the resultant point, Q, will be generated in the PPC representation. Step 4 brings the point Q back to the affine coordinates representation by applying the reverse transformation functions (RRPPC⁻¹) of the transformation functions of equation 4.2.

Algorithm 6.2: Countermeasure 2

| | |
|---|---|
| INPUT | K,P |
| OUTPUT | KP |

```
1.  Lₓ=Rand(1..N)
2.  L_{y}=Rand(1..N) such that L_{y} − Lₓ ≧ 0
3.  P =RRPPC(P)
4.  Any scalar multiplication algorithm
        For ADD Use Formulas 5.18
        For DBL Use Formulas 5.27
    Q←Output of the algorithm
5.  R=RRPPC⁻¹(Q)
return (R)
```

The third countermeasure is based on the optimized PPC addition and doubling formulas of equations 5.18 and 5.27 in conjunction with selecting Lₓ and L_{y} according to the rule: L_{y}=Lₓ. This countermeasure uses the optimized PPC addition formulas of 5.18 and the optimized PPC doubling formulas of 5.27. The steps of the third countermeasure are shown in Algorithm 6.3 and can be summarized as follows:

Step 1: randomly select Lₓ value in the range from 1 to N;

Step 2: set L_{y}=Lₓ;

Step 3: project the base point P to the point \tilde{P} using the parameterized transformation functions of equation 4.2. The projected point \tilde{P} is then used as input to the scalar multiplication algorithm. The output of the scalar multiplication algorithm is the point Q; and,

Step 4: since the scalar multiplication uses the optimized PPC formulas for both addition and doubling operations, the resultant point, Q, will be generated in the PPC representation. Step 4 brings the point Q back to the affine coordinates representation by applying the reverse transformation functions (RRPPC⁻¹) of the transformation functions of equation 4.2.

Algorithm 6.3: Countermeasure 3

| | |
|---|---|
| INPUT | K,P |
| OUTPUT | KP |

```
1.  Lₓ=Rand(1..N)
2.  Set L_{y}=Lₓ
3.  P=RRPPC(P)
4.  Any scalar multiplication algorithm
        For ADD Use Formulas 5.18
        For DBL Use Formulas 5.27
    Q←Output of the algorithm
5.  R=RRPPC⁻¹(Q)
return (R)
```

In conclusion, the method for elliptic curve scalar multiplication using parameterized projective coordinates increases the efficiency of elliptic curve cryptosystems used for communications over an insecure communications channel. The insecure communications channel may be, e.g., a telephone network, such as a cellular telephone network; the Internet, where cryptographic systems may be employed for security in e-commerce payment transactions conducted through a web browser via Hypertext Transfer Protocol (HTTP), or for the security of electronic mail messages conducted via Simple Mail Transfer Protocol (SMTP) and POP3 protocols, or for confidential file transfers via File Transfer Protocol (FTP); or for smart card transactions between a smart card (a plastic card having an embedded microprocessor and limited memory) and a server via a smart card reader and transmission line for credit card or bank transactions, identification cards, access cards, and the like.

Further, the method may be employed for key exchange in a public-key cryptosystem, for digital signatures, and for the encryption of plaintext messages or data, all of which require scalar multiplication of the form kP, wherein k is a scalar and P is a point on an elliptic curve. The method of the present invention may be particularly useful in connection with smart cards, wherein the small key size and limited data transfer (identification data, account numbers, etc.) make elliptic curve cryptographic methods particularly advantageous, although the quicker execution time and lower memory storage requirements of the method enhance data encryption over any insecure communications channel.

The present invention would also extend to any cryptographic device programmed to, or having dedicated circuits configured to, execute the steps of the method, including a computer, a microprocessor or microcontroller, a digital signal processor, an Application Specific Integrated Circuit (ASIC), and may be implemented in a computer, telephone, radio transceiver, smart card, or any other communications device. Further, the present invention extends to any computer readable media having instructions stored thereon that, when loaded into main memory and executed by a processor, carries out the steps of the method, including: integrated circuit memory chips; hard disk drives; floppy disk drives; magnetic or optical memory media, including compact disks (CD) and digital versatile disks (DVD); and any other media capable of storing instructions executable by a processor when loaded into main memory.

It is to be understood that the present invention is not limited to the embodiments described above, but encompasses any and all embodiments within the scope of the following claims.

We claim:

1. A method for elliptic curve scalar multiplication in an elliptic curve cryptosystem implemented over an insecure communications channel, comprising the steps of:
(a) selecting positive integers Lₓ and L_{y}, wherein Lₓ and L_{y} are not both equal to 1, and wherein L_{y}≠3 if Lₓ=2;
(b) representing coordinates of a point P=(x,y) on an elliptic curve of the form F(x,y)=y²−x³−ax−b=0 defined over a finite field as projective coordinates according to transforms
$$x = \frac{X}{{Z}^{Lx}} and y = \frac{Y}{{Z}^{{L}_{y}}} ,$$
respectively; and
(c) adding together K copies, K being a scalar, of the point P(X,Y) to obtain the scalar multiplication product KP.

2. The method for elliptic curve scalar multiplication according to claim 1, further comprising the step of converting the scalar multiplication product from parameterized projective coordinates P(X,Y,L^{x},L^{y}) to affine coordinates P(x,y).

3. The method for elliptic curve scalar multiplication according to claim 2, wherein step (c) comprises performing a plurality of point addition and point doubling operations in an order corresponding to a binary representation of the scalar, K.

4. The method for elliptic curve scalar multiplication according to claim 3, wherein the order corresponds to the most significant digit to the least significant digit in the binary representation of the scalar, K.

5. The method for elliptic curve scalar multiplication according to claim 3, wherein step (c) further comprises at least one dummy addition when a corresponding digit of the scalar, K, is equal to zero in order to defeat a differential power analysis attack.

6. The method for elliptic curve scalar multiplication according to claim 3, wherein the order corresponds to the least significant digit to the most significant digit in the binary representation of the scalar, K.

7. The method for elliptic curve scalar multiplication according to claim 2, further comprising the steps of keeping the scalar private and making the point P(X,Y) and the scalar multiplication product, KP, public for establishing elliptic curve public-key agreement.

8. The method for elliptic curve scalar multiplication according to claim 2, further comprising the steps of:
embedding a plaintext message onto a point on the elliptic curve to form a message point; and
adding the message point to the scalar multiplication product, KP, in order to encrypt the plaintext message.

9. The method for elliptic curve scalar multiplication according to claim 1, wherein step (a) comprises automatically generating Lₓ and L_{y} from a random number generator.

10. The method for elliptic curve scalar multiplication according to claim 1, wherein 0<Lₓ≦N and 0<L_{y}≦N, where N is the number of bits in a binary representation of the coordinates x and y of point P.

11. The method for elliptic curve scalar multiplication according to claim 1, wherein step (a) further comprises the steps of:
selecting Lₓ before L_{y}; and
further restricting L_{y} so that L_{y}−Lₓ≧0, whereby point addition and point doubling operations required by step (c) are optimized.

12. The method for elliptic curve scalar multiplication according to claim 1, wherein step (a) further comprises the steps of:
selecting Lₓ before L_{y}; and
further restricting L_{y} so that L_{y}=Lₓ, whereby point addition and point doubling operations required by step (c) are optimized.

13. A cryptographic device for elliptic curve scalar multiplication in an elliptic curve cryptosystem implemented over an insecure communications channel, the device comprising:
(a) means for selecting positive integers Lₓ and L_{y}, wherein Lₓ and L_{y}, are not both equal to 1, and wherein L_{y}≠3 if Lₓ=2;
(b) means for representing coordinates of a point P=(x,y) on an elliptic curve of the form F(x,y)=y²−x³−ax−b=0 defined over a finite field as projective coordinates according to transforms
$$x = \frac{X}{{Z}^{{L}_{x}}} and y = \frac{Y}{{Z}^{{L}_{y}}} ,$$
respectively;
(c) means for adding together K copies, K being a scalar, of the point P(X,Y) to obtain the scalar multiplication product KP, and
(d) means for converting the scalar multiplication product from parameterized projective coordinates P(X,Y,L^{x},L^{y}) to affine coordinates P(x,y).

14. The cryptographic device according to claim 13, wherein L_{y}−Lₓ≧0.

15. The cryptographic device according to claim 13, wherein L_{y}=Lₓ.

16. The cryptographic device according to claim 13, wherein the device comprises a computer having a processor for carrying out means (a) through (d).

17. The cryptographic device according to claim 13, wherein the device comprises a telephone having a processor for carrying out means (a) through (d).

18. The cryptographic device according to claim 13, wherein the device comprises a smart card having a processor for carrying out means (a) through (d).

19. The cryptographic device according to claim 15, wherein the device comprises an application specific integrated circuit (ASIC) having circuitry for carrying out means (a) through (d).

20. A computer product comprising a medium readable by a computer, the computer having a processor and an area of main memory, the medium having stored thereon a set of instructions, including:
(a) a first set of instructions which, when loaded into main memory and executed by the processor, causes the processor to select positive integers Lₓ and L_{y}, wherein Lₓ and L_{y} are not both equal to 1, and wherein L_{y≠}3 if Lₓ=2;
(b) a second set of instructions which, when loaded into main memory and executed by the processor, causes the processor to represent coordinates of a point P=(x,y) on an elliptic curve of the form F(x,y)=y²−x³−ax−b=0 defined over a finite field as projective coordinates according to transforms
$$x = \frac{X}{{Z}^{Lx}} and y = \frac{Y}{{Z}^{{L}_{y}}} ,$$
respectively;
(c) a third set of instructions which, when loaded into main memory and executed by the processor, causes the processor to add together K copies, K being a scalar, of the point P(X,Y) to obtain the scalar multiplication product KP, and
(d) a fourth set of instructions which, when loaded into main memory and executed by the processor, causes the processor to convert the scalar multiplication product from parameterized projective coordinates P(X,Y,L^{x},L^{y}) to affine coordinates P(x,y).
